(19) United States
(12) Patent Application Publication
(10) Pub. No.: US 2023/0139925 A1
(43) Pub. Date: May 4, 2023

(54) AUTOMATED ANALYTE MEASUREMENT SYSTEMS AND KITS FOR USE THEREWITH

(71) Applicant: Correlia Biosystems, Inc., Berkeley, CA (US)

(72) Inventors: M. Kursad Araz, El Cerrito, CA (US); Samuel Quinn Tia, Berkeley, CA (US); Akwasi Apori, Berkeley, CA (US); Pranav Sundaram, Emeryille, CA (US)

(21) Appl. No.: 17/794,978

(22) PCT Filed: Jan. 22, 2021
(86) PCT No.: PCT/US2021/014800

§ 371 Date: Jul. 24, 2022

Related U.S. Application Data
(60) Provisional application No. 62/965,725, filed on Jan. 24, 2020.
(60) Provisional application No. 62/965,729, filed on Jan. 24, 2020.

(51) Int. Cl. G01N 35/10; G01N 35/00; B01L 3/02

(52) U.S. Cl. CPC G01N 35/10; G01N 35/0099; B01L 3/0275; B01L 2300/0829; B01L 2300/0645; B01L 2300/0816; B01L 2300/042; B01L 2300/0861; B01L 2200/025; G01N 2035/0458

(57) ABSTRACT

Provided herein are a system, kit and methods that allow quick and precise detection, identification and quantification of analytes in liquid samples. The kit may be used in automated and pre-programmed singleplexed and multiplexed detection and quantification of one or more analytes in a liquid samples. The kit may include a chip caddy, consumable assay chips, an electrode assembly, an electrical connector assembly, one or more cables, a voltage supply, a vacuum pump, a vacuum trap, custom-designed manifolds, one or more buffers, reagents and instructions for use.

### CROSS-REFERENCE TO RELATED APPLICATIONS

This application claims the benefit of U.S. Provisional Application No. 62/965,725, filed Jan. 24, 2020, which is hereby incorporated by reference in its entirety.

This application claims the benefit of U.S. Provisional Application No. 62/965,729, filed Jan. 24, 2020, which is hereby incorporated by reference in its entirety.

### FIELD OF THE INVENTION

The present invention relates to kits for quick and precise detection, identification and quantification of small molecules and macromolecules, such as proteins, peptides, antibodies, nucleic acid markers, hormones, metabolites, carbohydrates, lipids and other analytes of interest, in liquid samples. The disclosed kits may be used for research, clinical applications, diagnosis and treatment.

The present invention also relates to a system for quick and precise detection, identification and quantification of small molecules and macromolecules, such as proteins, peptides, antibodies, nucleic acid markers, hormones, metabolites, carbohydrates, lipids and other analytes of interest, in liquid samples, and to methods of analyte detection and quantification that comprise the use of the disclosed system. The disclosed system may be used for research, clinical applications, and for diagnosis and treatment purposes.

### BACKGROUND

Early detection and quantification of protein biomarkers are crucial for treatment and prevention strategies. While commercially available immunoassay techniques for protein detection and quantification are reasonably inexpensive, they suffer from considerable drawbacks.

In particular, most commercially available tests require the use of one or more antibodies with high specificity and sensitivity for a particular protein at a time and many of these tests are not always suitable to perform multiplexed detection. Thus, multiple assays often need to be performed on each sample if multiplexed protein analysis is desired. In addition, most immunoassays are laborious and time-consuming, have multiple steps, and require hands-on user intervention.

Several approaches have been attempted to make immunoassays faster and user-friendly. However, these techniques still require several hours of time and relatively large volumes of liquid samples. Therefore, immunoassays often constitute an impediment to producing high quality real time quantitative protein measurement data within the life science disciplines. This is especially true when limited biosample quantities are available.

There is a need for an accurate and reliable system, kits and methods that quickly and reliably detect and quantify proteins and other analytes for research and for diagnosis and preventive and therapeutic guidance. The present application presents a solution to the aforementioned challenges by providing kit components that can be fit into various automated liquid handling systems, and provide rapid and highly efficient measurements of macromolecules.

### SUMMARY

Summary Regarding Kit used with Automated System

Disclosed herein are kit components that fit into automated liquid handling systems and provide rapid and highly efficient multiplex detection and quantification of small molecules and macromolecules, such as proteins, peptides, antibodies, nucleic acids, biomarkers, hormones, metabolites, carbohydrates and lipids of interest, in liquid samples. The disclosed kits may be used on microquantities of liquid samples for a large number of tests, such as immunoassays, nucleic acid tests, clinical diagnostics, biomarker detection, and proteomic profiling, with no or limited manual interventions from the user.

Thus, provided herein are kits for automated and pre-programmed singleplex and multiplex analyte detection and quantification from liquid samples.

In some embodiments, the disclosed kits may include one or more of a chip caddy, consumable assay chips, an electrode assembly, a connector assembly comprising a lid and a printed circuit board (PCB) interface, cables, a voltage power supply, a vacuum pump, a vacuum trap, and custom-designed fluid delivery and aspiration manifolds fitting different size liquid handling robot arms, and may further comprise one or more buffers, reagents and instructions for use.

The disclosed components of the kits provided herein are configured to fit into different automated systems for singleplex or multiplex detection and quantification of macromolecules, and to be connected to different types of automated imagers. Moreover, the disclosed components of the kits provided herein are configured to be used for a large number of tests, such as immunoassays, nucleic acid tests, multiplexed protein measurements, clinical diagnostics, biomarker detection, and proteomic profiling, for the detection and quantification of proteins, nucleic acids, biomarkers, hormones, metabolites, carbohydrates and lipids of interest, in liquid samples. Liquid samples may vary in volume from about 0.2 μl to about 1000μl.

The disclosed components of the kits provided herein are configured to connect to different types of automated imagers. Suitable automated imagers may comprise a LED or laser-induced fluorescence imaging reader equipped with fluorescence excitation sources, optical filters, a photon measurement system (such as a camera or a photomultiplier tube system), objective lenses, exposure and light intensity active monitoring and regulation systems, and automated image analysis and reporting systems.

In some embodiments, the assay chips are microfluidic chips that comprise glass or one or more polymers. In some embodiments the assay chips are functionalized printed circuit boards (PCBs). In some embodiments, the assay chips are paper-based and comprise cellulosic materials such as organic fibers.

In some embodiments, the chip caddy in the disclosed kits is configured to contain assay chips. In some embodiments, the consumable assay chips are single use chips. In some embodiments, the consumable assay chips are reusable chips. In some embodiments, the assay chips are configured to comprise wells designed to accept multiple samples and reagents for multiplex analyte detection and quantification.

In some embodiments, the chip caddy comprises one or more metals, such as aluminum, a polymer, or any mixture thereof. In some embodiments, the chip caddy in the disclosed kits is configured to contain 1 or more chips. In some embodiments, each chip contains 2 sample wells. In some embodiments, each chip caddy contains 16 sample wells, 64 sample wells, 256 sample wells, 640 sample wells, 1280 sample wells, 3200 sample wells, or 6400 sample wells. In some embodiments, each well has a diameter from about 1 mm to about 5 mm, or from about 1.5 mm to about 3 mm. In some embodiments, two or more wells are connected via channels.

In some embodiments, the electrode assembly is configured to fit into the connector assembly and to hold consumable assay chips. In some embodiments, the electrode assembly is configured to comprise a hinged precision electrode interface connectable to the programmable voltage power supply. The voltage power supply may comprise from one to ten independent outputs.

In some embodiments, the electrode assembly is configured to comprise a bottom component housing a spring mechanism configured to align a chip caddy within the electrode assembly and a top lid comprising an insulating electrode frame holding electrode rails. In some embodiments, the electrode rails are configured to be straight and aligned flat and parallel to the chip caddy. In some embodiments, the electrode assembly is configured to be in open or closed position. In some embodiments, the electrode assembly is configured to be removable from the connector assembly. In some embodiments, the electrode assembly can be washed, bleached and disinfected and used for additional tests.

In some embodiments, the connector assembly is configured to be attachable to an automated liquid handling robot's base. In some embodiments, the connector assembly is configured to transmit electricity to the electrode rails within the electrode assembly.

In some embodiments, when the connector assembly and the electrode assembly within the connector assembly are in closed position, each electrode in the electrode rails is configured to sit on the edge of each well and to receive electricity through the connector assembly. In some embodiments, each electrode has a thickness between 0.1 mm and 1 mm, or between 0.3 mm and 0.7 mm. In some embodiments, each electrode is a laser-welded platinum electrode comprising an angled top.

In some embodiments, the vacuum pump and the vacuum trap are configured to be connectable to a programmable voltage power supply. The voltage power supply may comprise from one to ten independent outputs.

In some embodiments, the software is configured to integrate and connect the liquid handling robot, the vacuum system, and the voltage power supply to fully automate the assay running steps and enable advanced data analysis.

In some embodiments, the software is configured to integrate and connect the liquid handling robot, the vacuum system, the voltage power supply and the imaging system, to fully automate the assay running steps and readout, and enable image analysis and advanced data analysis.

In some embodiments, the custom-designed fluid delivery and aspiration manifolds in the disclosed kits are configured to be connectable to a vacuum line and for macro tip or micro tip attachment.

In some embodiments, the disclosed components of the kits provided herein are configured to hold the consumable chips in place and maintain electrical conductivity within the wells in the chips. In some embodiments, the automated liquid handling robot is configured to deliver or aspirate one or more assay reagents in appropriate sequence to one or more wells in the consumable chips.

In some embodiments, the disclosed kit components are configured to fit into an automated analyte detection and quantification system with direct sampling capabilities. The disclosed system comprises an automated liquid handling robot and an assay subunit.

In some embodiments, the automated liquid handling robot is a custom-designed robot having microliter pipetting capabilities, and programmed to deliver, add, aspirate or remove liquids from sample wells at defined time intervals or in pre-determined conditions. In some embodiments the liquid handling robot is capable of automatically carrying out all necessary sample preparation steps before an assay, such as reagent mixing and sample dilutions.

In some embodiments, the automated liquid handling robot comprises a custom-designed arm comprising an aspiration manifold connected to a vacuum line and configured for micro tip attachment.

In some embodiments, the system comprises the connector assembly, the electrode assembly configured to fit in the connector assembly and to hold consumable assay chips, and comprising a hinged precision electrode interface, the vacuum pump, and the programmable voltage power supply comprising one to ten independent outputs connected to the electrode interface.

In some embodiments, an automated imager is integrated with the system. In some embodiments, the automated imager is separate from the system. In some embodiments, the automatic imager comprises a LED or laser-induced fluorescence imaging reader equipped with fluorescence excitation channels, optical filters, a photon measurement system, such as camera or a photomultiplier tube system, objective lenses, systems for autofocus, auto-exposure, light intensity monitoring and regulation, and automated image analysis and reporting systems.

In some embodiments, the software integrates and connects the liquid handling robot, the vacuum system, the voltage power supply and the imaging system, to enable image analysis and advanced data analysis.

In some embodiments, the automated liquid handling robot is configured to deliver or aspirate one or more assay reagents in appropriate sequence to one or more wells in the consumable chips.

In some embodiments, the disclosed automated system is configured to detect the presence of one or more analytes of interest in a liquid sample and quantify detected amounts of one or more analytes within a period of time from about 10 minutes to about 4 hours. Liquid samples may include, but are not limited to, biological samples, such as blood, serum, and urine, cell suspensions, cell supernatants and lysates, plant extracts, sea water, microfilm fluids, running water, and beverages.

In some embodiments, the disclosed automated system is configured to detect and quantify macromolecules, such as proteins, peptides, antibodies, nucleic acids, biomarkers, hormones, metabolites, carbohydrates and lipids of interest, from liquid samples. Suitable detection methods include, but are not limited to, immunoassays, nucleic acid tests, clinical diagnostics, biomarker detection, and proteomic profiling.

In some embodiments, the disclosed automated system is configured to allow one or more liquid samples and one or more reagents to be introduced separately and at different times into the system. The disclosed automated system is configured to detect and quantify one or more analytes in liquid samples that are in an amount from about 0.2 μl sample to about 1000 μl sample. Additionally, the disclosed automated system is configured to detect and quantify one or more analytes within a period of time, such as from about 10 minutes to about 4 hours.

The disclosed automated system is configured to apply directional electric field to the assay chips, such that one or more reagents are electrokinetically and sequentially transported from one well to the other. The disclosed automated system is also configured to allow the liquid handling robot to precisely transfer, dispense into, deliver to or aspirate from different samples one or more reagents at different times or in different cycles, in order to carry out sample preparation steps, or capture and bind target analytes. In some embodiments, capturing and binding target analytes may include, but are not limited to, sandwich antibody detection, enzyme-labeled antigen reaction, fluorometric detection, in situ hybridization, microarray technology, affinity binding, radioactive and colorimetric binding.

Summary Regarding Automated System

Also, disclosed herein are an automated system and automated methods for rapid and highly efficient multiplex detection and quantification of small molecules and macromolecules, such as proteins, peptides, antibodies, nucleic acids, biomarkers, hormones, metabolites, carbohydrates and lipids of interest, from liquid samples. The disclosed automated system and methods may be used on microquantities of liquid samples for a large number of tests, such as immunoassays, nucleic acid tests, multiplex diagnostics, biomarker detection, and proteomic profiling, with no or limited manual interventions from the user.

Thus, in one embodiment, provided herein is an automated analyte detection and quantification system with direct sampling capabilities. The disclosed system comprises an automated liquid handling robot and an assay subunit.

In some embodiments, the automated liquid handling robot is a custom-designed robot having microliter pipetting capabilities, and programmed to deliver, add, aspirate or remove liquids to and from sample wells at defined time intervals or in pre-determined conditions.

In some embodiments, the automated liquid handling robot comprises a custom-designed and manufactured arm comprising an aspiration manifold connected to a vacuum line and configured for micro tip attachment.

In some embodiments, the assay subunit is a system that comprises a connector assembly comprising a lid and a printed circuit board (PCB) interface with conductive pins, an electrode assembly configured to fit into the connector assembly and to hold consumable assay chips, and comprising a hinged precision electrode interface, a vacuum pump, and a programmable, software-controlled voltage power supply connected to the electrode interface comprising from one to ten independent outputs.

In some embodiments, an automated imager is integrated into the system. In some embodiments, the automated imager is separate from the system. In some embodiments, the automatic imager comprises a LED or laser-induced fluorescence imaging reader, which may be equipped with a microscope, fluorescence excitation channels, optical filters, a photon measurement system, objective lenses, systems for autofocus, auto exposure, light intensity active monitoring and regulation, and an automated image analysis and reporting system.

In some embodiments, the software is configured to integrate and connect the liquid handling robot, the vacuum system, the voltage power supply and the imaging system, to enable image analysis and advanced data analysis.

In some embodiments, the connector assembly is fixed to a plate at the automated liquid handling robot's base. In some embodiments, the hinged precision electrode interface comprises multiple electrode rails. In some embodiments, the connector assembly is configured to transmit electricity to the electrode rails within the electrode assembly.

In some embodiments, the electrode assembly comprises a bottom component housing a spring mechanism configured to align a chip caddy within the electrode assembly, and a top lid comprising an insulating electrode frame holding the electrode rails. In some embodiments, the electrode rails are configured to be straight and aligned flat and parallel to the chip caddy. In some embodiments, the electrode assembly is configured to be in either an open or closed position. In some embodiments, the electrode assembly is removable from the connector assembly. In some embodiments, the electrode assembly can be washed, bleached, disinfected and reused.

In some embodiments, the assay chips are microfluidic chips comprising glass or one or more polymers. In some embodiments the assay chips comprise functionalized microcapillaries composed of glass and/or polymer. In some embodiments the assay chips are functionalized printed circuit boards (PCBs). In some embodiments, the assay chips are paper-based devices comprising cellulosic materials, such as organic fibers.

In some embodiments, the consumable assay chips are contained in a chip caddy. In some embodiments, the consumable assay chips are single use chips. In some embodiments, the consumable assay chips are reusable chips. The consumable assay chips contain wells designed to accept multiple samples and reagents for multiplex analyte detection and quantification.

In some embodiments, the chip caddy comprises one or more metals, such as aluminum, one or more polymers such as plastic, or any mixture thereof. In some embodiments, the chip caddy contains 1 or more microfluidic chips or assay chips. In some embodiments, each chip contains 2 sample wells. In some embodiments, each chip caddy contains 16 sample wells, 64 sample wells, 256 sample wells, 640 sample wells, 1280 sample wells, 3200 sample wells, or 6400 sample wells. In some embodiments, each well has a diameter from about 1 mm to about 5 mm, or from about 1.5 mm to about 3 mm. In some embodiments, two or more wells are connected by channels.

In some embodiments, when the connector assembly and the electrode assembly within the connector assembly are in closed positions, each electrode in the electrode rails is configured to sit on the edge of each well and to receive electricity through the connector assembly. In some embodiments, each electrode has a thickness between 0.1 mm and 1 mm, or between 0.3 mm and 0.7 mm. In some embodiments, each electrode is a laser-welded platinum electrode comprising an angled top.

In some embodiments, the assay subunit is configured to hold the consumable chips in place and maintain electrical conductivity within the wells in the chips. In some embodiments, the automated liquid handling robot is configured to deliver or aspirate one or more assay reagents in appropriate sequence to one or more wells in the consumable chips.

In some embodiments, the disclosed automated system is configured to detect the presence of one or more analytes of interest in a liquid sample and quantify detected amounts of one or more analytes within a period of time from about 10 minutes to about 4 hours. Liquid samples may include, but are not limited to, biological samples, such as blood, serum, and urine, cell suspensions, cell supernatants and lysates, plant extracts, sea water, microfilm fluids, running water, and beverages.

In some embodiments, the disclosed automated system is configured to detect and quantify macromolecules, such as proteins, peptides, antibodies, nucleic acids, biomarkers, hormones, metabolites, carbohydrates and lipids of interest, from liquid samples. Suitable detection methods include, but are not limited to, immunoassays, nucleic acid tests, multiplex diagnostics, biomarker detection, and proteomic profiling.

In some embodiments, the disclosed automated system is configured to allow one or more liquid samples and one or more reagents to be introduced separately and at different times into the system. The disclosed automated system is configured to detect and quantify one or more analytes in liquid samples that are in a volume amount from about 0.2₁11 to about 1000μl.

The disclosed automated system is configured to apply directional electric field to the electrode assembly, such that one or more reagents are electrokinetically and sequentially transported through the system to the one or more samples. The disclosed automated system is also configured to allow the liquid handling robot to precisely transfer, dispense into, deliver to or aspirate from different samples one or more reagents at different times or in different cycles, in order to capture and bind target analytes. In some embodiments, capturing and binding target analytes may include, but are not limited to, sandwich antibody detection, enzyme-labeled antigen reaction, fluorometric detection, in situ hybridization, microarray technology, affinity binding, radioactive and colorimetric binding.

Also provided herein are automated methods for singleplex and multiplex detection and quantification of one or more analytes in a liquid sample, which require minimal or no manual interventions. The disclosed automated methods comprise (a) separately introducing the liquid sample and one or more reagents into an automated analyte detection and quantification system with direct sampling capabilities as described above; (b) choosing an assay protocol from a list of pre-validated assay protocols to detect and quantify one or more target analytes; (c) closing the connector assembly and the electrode assembly underneath the connector assembly; (d) starting the automated system; (e) waiting 10 to 240 minutes; and (f) calculating target analyte concentrations from detection and quantification data presented by the automated system.

The foregoing and other features of the disclosure will become more apparent from the following detailed description of several embodiments, which proceeds with reference to the accompanying figures.

The foregoing and other features of the disclosure will become more apparent from the following detailed description of several embodiments, which proceeds with reference to the accompanying figures.

### BRIEF DESCRIPTION OF THE DRAWINGS

The present disclosure will become better understood from the detailed description and the drawings, wherein:

FIG. 1A illustrates a diagram showing an example liquid handling robot.

FIG. 1B illustrates a diagram showing control of system components.

FIGS. 2A and 2B illustrate diagrams showing delivery of consumables into sample wells.

FIGS. 3A, 3B and 3C illustrates examples of four assay chips in a caddy.

FIGS. 4A and 4B illustrate a diagram showing a close-up view of the electrodes an electrode assembly.

FIGS. 5A, 5B, 5C and 5D illustrate diagrams showing assemblies in an open position.

FIGS. 6A and 6B illustrate diagrams showing assembly with conductive pins.

FIG. 7. illustrates a diagram showing an example vacuum arm designed to fit the liquid handling robot.

FIGS. 8A and 8B illustrate diagrams showing the connector assembly in the open position.

FIGS. 9A, 9B and 9C illustrate diagrams showing examples of the connector assembly in modes of operation.

FIGS. 10A, 10B illustrate diagrams showing the electrode assembly in modes of operation.

FIG. 10C illustrates a diagram showing the chip caddy in a mode of operation.

FIG. 11A-11D illustrate diagrams showing the electrode frame and electrode rails in the electrode assembly.

FIGS. 12A, 12B and 12C illustrate diagrams showing views of the electrode frame and electrode rail placement.

FIGS. 13A and 13B illustrate diagrams showing placement of electrode tips and electrode rail placement.

FIG. 14 illustrates a diagram showing a detailed view of the electrode and pipette tip placement.

FIG. 15 illustrates a diagram showing a standard curve for the human IL-1 Beta assay.

FIG. 16 illustrates a flowchart of a method for an automated method for singleplex and multiplex detection and quantification of one or more analytes in a liquid sample.

FIG. 17 illustrates a flowchart of a method for an automated method for singleplex and multiplex detection and quantification of one or more analytes in a liquid sample.

### DETAILED DESCRIPTION

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. For example, reference to “comprising a therapeutic agent” includes one or a plurality of such therapeutic agents. The term “or” refers to a single element of stated alternative elements or a combination of two or more elements, unless the context clearly indicates otherwise. For example, the phrase “A or B” refers to A, B, or a combination of both A and B. Furthermore, the various elements, features and steps discussed herein, as well as other known equivalents for each such element, feature or step, can be mixed and matched by one of ordinary skill in this art to perform methods in accordance with principles described herein. Among the various elements, features, and steps some will be specifically included and others specifically excluded in particular examples.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. All references cited herein are incorporated by reference in their entirety.

In some examples, the numbers expressing quantities of ingredients, properties such as molecular weight, reaction conditions, and so forth, used to describe and claim certain embodiments are to be understood as being modified in some instances by the term “about” or “approximately.” For example, “about” or “approximately” can indicate +/−20% variation of the value it describes. Accordingly, in some embodiments, the numerical parameters set forth herein are approximations that can vary depending upon the desired properties for a particular embodiment. Notwithstanding that the numerical ranges and parameters setting forth the broad scope of some examples are approximations, the numerical values set forth in the specific examples are reported as precisely as practicable. The recitation of ranges of values herein is merely intended to serve as a shorthand method of referring individually to each separate value falling within the range.

To facilitate review of the various embodiments of this disclosure, the following explanations of specific terms are provided:

Administer or Apply: To provide or give a subject a composition, such as a pharmaceutical composition, by an effective route. Exemplary routes of administration include, but are not limited to, parenteral, topical, transdermal, oral, intravenous, and muscular routes.

Analog: A compound having a structure similar to another, but differing from it, for example, in one or more atoms, functional groups, or substructure.

Anesthetic agent: An active agent that causes reduction or loss of sensation.

Antagonist: A molecule that, upon binding to a cell receptor, competes and/or interferes with one or more ligands binding the same receptor, and thus reduces or prevents a response elicited by those ligands.

Antibiotic: A chemical substance capable of treating bacterial infections by inhibiting the growth of, or by destroying existing colonies of bacteria and other microorganisms.

Antibody: An immunoglobulin capable of specifically binding a target molecule, such as a carbohydrate, a polynucleotide, a lipid, or a polypeptide, via one or more antigen recognition sites, located in the variable region of the immunoglobulin molecule. The term “antibody” includes polyclonal and monoclonal antibodies, fragments thereof, such as Fab, Fab′, F(ab′)2 and Fv, single chain variable fragments (ScFv), mutants thereof, fusion proteins comprising an antibody portion, and any other modified configuration of the immunoglobulin molecule that comprises an antigen recognition site. Antibodies can be distinguished into five major classes, IgA, IgD, IgE, IgG, and IgM, according to the amino acid sequence of the constant domain in their heavy chains. Monoclonal antibodies are obtained from a substantially homogeneous population of antibodies, and specifically target a single epitope (determinant) of an antigen. Polyclonal antibodies target different epitopes on the antigen. The heavy and light chains of an antibody each comprise a variable region and a constant region. The variable regions of the heavy and light chain each consist of four framework regions (FR) connected by three complementarity-determining regions (CDRs), also known as hypervariable regions. The CDRs in each chain are held together in close proximity by the FRs and form the antibody's antigen-binding site. The constant regions of the heavy and light chains of an antibody provide structural stability and are not involved in antigen binding.

Antibody-drug conjugate (ADC): Complex molecules composed of an antibody linked to a biologically active cytotoxic payload or drug. By combining the targeting capabilities of monoclonal antibodies with the cancer-killing ability of cytotoxic drugs, antibody-drug conjugates allow for discrimination between healthy and diseased tissue. Unlike traditional chemotherapeutic drugs, antibody-drug conjugates target only cancer cells so that healthy cells are less severely affected.

Anti-Fungal Agent: An active agent capable of inhibiting the growth of or destroying fungi.

Anti-inflammatory agent: An active agent that reduces inflammation and swelling.

Anti-Oxidant: An active agent that inhibits oxidation or reactions promoted by oxygen or peroxides.

Anti-Protozoal Agent: An active agent capable of inhibiting the growth of or destroying protozoa microorganisms.

Anti-Viral Agent: An active agent that inhibits the replication of or destroys viruses.

Cancer: A condition characterized by unregulated cell growth. Examples of cancer include, but are not limited to, squamous cell cancer, small-cell lung cancer, non-small cell lung cancer, lung adenocarcinoma, lung squamous cell carcinoma, gastrointestinal cancer, Hodgkin's and non-Hodgkin's lymphoma, pancreatic cancer, glioblastoma, cervical cancer, glioma, ovarian cancer, liver cancer such as hepatic carcinoma and hepatoma, bladder cancer, breast cancer, colon cancer, colorectal cancer, endometrial or uterine carcinoma, salivary gland carcinoma, kidney cancer such as renal cell carcinoma and Wilms' tumors, basal cell carcinoma, melanoma, prostate cancer, thyroid cancer, testicular cancer, esophageal cancer, and various types of head and neck cancer.

Chemotherapeutic agent or Chemotherapy: A chemical agent with therapeutic usefulness in the treatment of diseases characterized by abnormal cell growth. Such diseases include tumors, neoplasms, and cancer. In one example, a chemotherapeutic agent is a radioactive compound. In one example, a chemotherapeutic agent is a biologic, such as a monoclonal antibody. In some examples, a subject treated with an active agent using the disclosed methods, is, will be, or was previously treated with chemotherapy. Exemplary chemotherapeutic agents are provided in Slapak and Kufe, Principles of Cancer Therapy, Chapter 86 in Harrison's Principles of Internal Medicine, 14th edition; Perry et al., Chemotherapy, Ch. 17 in Abeloff, Clinical Oncology 2nd ed., 2000 Churchill Livingstone, Inc; Baltzer and Berkery. (eds): Oncology Pocket Guide to Chemotherapy, 2nd ed. St. Louis, Mosby-Year Book, 1995; Fischer Knobf, and Durivage (eds): The Cancer Chemotherapy Handbook, 4th ed. St. Louis, Mosby-Year Book, 1993).

Chimeric Antibody: An antibody having a variable region or part of variable region from a first species of a mammal and a constant region from a second species of a mammal.

Congenital Disorder: A condition or disease present at birth, which is inherited or brought about by environmental factors, such as the mother's alcohol or drug consumption, nutritional intake and placental health. Examples of congenital disorders include, but are not limited to, congenital heart defect, cleft lip, sickle cell disease, alpha-thalassemia, beta-thalassemia, spinal muscular atrophy, spina bifida and Down syndrome.

Consumables: Laboratory equipment and reagents that must be replaced regularly as they wear out or are used. Consumable may include, but are not limited to, reagents, buffers, disposable test tubes, beakers, pipettes, strips, gloves, facemasks, sample containers, syringes, centrifuge tubes, and swabs.

Contacting: Placement in direct physical association; includes both in solid and liquid form. Contacting can occur in vitro with isolated cells (for example in a tissue culture dish or other vessel) or in vivo by administering an active agent to a subject.

Control: A reference standard. In some examples, a control is a known value or range of values, such as one indicative of the presence or the absence of cystic fibrosis. In some examples, a control is a value or range of values, indicating a response in the absence of a therapeutic agent.

Cytokine: A substance released by one cell population that acts on another cell as intercellular mediator. Examples of cytokines include, but are not limited to, lymphokines, monokines; interleukins (ILs) such as IL-1, IL-la, IL-2, IL-3, IL-4, IL-5, IL-6, IL-7, IL-8, IL-9, IL-11, IL-12, IL-15, including PROLEUKIN® rIL-2; a tumor necrosis factor such as TNF-α or TNF-β; and other polypeptide factors including LIF and kit ligand (KL).

Cytotoxic agent: A substance that inhibits or prevents the function of cells and/or causes destruction of cells.

Domain: A distinct functional and/or structural unit of a protein. A conserved domain refers to a domain that has been conserved during evolution. During evolution, changes at specific positions of an amino acid sequence in the protein have occurred in a way that preserve the physico-chemical properties of the original residues, and hence the structural and/or functional properties of that region of the protein.

Drug or Active Agent: A chemical substance or compound that induces a desired pharmacological or physiological effect, and includes therapeutically effective, prophylactically effective, or systematically effective agents. The terms also encompass pharmaceutically acceptable, pharmacologically active derivatives and analogs of those active agents specifically mentioned herein, including, but not limited to, salts, esters, amides, pro-drugs, active metabolites, inclusion complexes, analogs, and the like. Suitable active agents that may be incorporated into the pharmaceutical compositions provided herein include, but are not limited to, adrenergic agents; adrenocortical steroids; adrenocortical suppressants; alcohol deterrents; aldosterone antagonists; amino acids; ammonia detoxicants; anabolic agents; analeptic agents; analgesic agents; androgenic agents; anesthetic agents; anorectic compounds; anorexic agents; antagonists; anterior pituitary activators and anterior pituitary suppressants; anti-acne agents; anti-adrenergic agents; anti-allergic agents; anti-amebic agents; anti-androgen agents; anti-anemic agents; anti-anginal agents; anti-anxiety agents; anti-arthritic agents; anti-asthmatic agents and other respiratory drugs; anti-atherosclerotic agents; anti-bacterial agents; anti-cancer agents, including antineoplastic drugs, and anti-cancer supplementary potentiating agents; anticholinergics; anticholelithogenic agents; anti-coagulants; anti-coccidal agents; anti-convulsants; anti-depressants; anti-diabetic agents; anti-diarrheals; anti-diuretics; antidotes; anti-dyskinetics agents; anti-emetic agents; anti-epileptic agents; anti-estrogen agents; anti-fibrinolytic agents; anti-fungal agents; anti-glaucoma agents; antihelminthics; anti-hemophilic agents; anti-hemophilic Factor; anti-hemorrhagic agents; antihistamines; anti-hyperlipidemic agents; anti-hyperlipoproteinemic agents; antihypertensive agents; anti-hypotensives; anti-infective agents such as antibiotics and antiviral agents; anti-inflammatory agents, both steroidal and non-steroidal; anti-keratinizing agents; anti-malarial agents; antimicrobial agents; anti-migraine agents; anti-mitotic agents; anti-mycotic agents; antinauseants; antineoplastic agents; anti-neutropenic agents; anti-obsessional agents; anti-parasitic agents; antiparkinsonism drugs; anti-pneumocystic agents; anti-proliferative agents; anti-prostatic hypertrophy drugs; anti-protozoal agents; antipruritics; anti-psoriatic agents; antipsychotics; antipyretics; antispasmodics; anti-rheumatic agents; anti-schistosomal agents; anti-seborrheic agents; anti-spasmodic agents; anti-tartar and anti-calculus agents; anti-thrombotic agents; anti-tubercular agents; antitussive agents; anti-ulcerative agents; anti-urolithic agents; antiviral agents; GERD medications, anxiolytics; appetite suppressants; attention deficit disorder (ADD) and attention deficit hyperactivity disorder (ADHD) drugs; bacteriostatic and bactericidal agents; benign prostatic hyperplasia therapy agents; blood glucose regulators; bone resorption inhibitors; bronchodilators; carbonic anhydrase inhibitors; cardiovascular preparations including anti-anginal agents, anti-arrhythmic agents, beta-blockers, calcium channel blockers, cardiac depressants, cardiovascular agents, cardioprotectants, and cardiotonic agents; central nervous system (CNS) agents; central nervous system stimulants; choleretic agents; cholinergic agents; cholinergic agonists; cholinesterase deactivators; coccidiostat agents; cognition adjuvants and cognition enhancers; cough and cold preparations, including decongestants; depressants; diagnostic aids; diuretics; dopaminergic agents; ectoparasiticides; emetic agents; enzymes which inhibit the formation of plaque, calculus or dental caries; enzyme inhibitors; estrogens; fibrinolytic agents; fluoride anticavity/antidecay agents; free oxygen radical scavengers; gastrointestinal motility agents; genetic materials; glucocorticoids; gonad-stimulating principles; hair growth stimulants; hemostatic agents; herbal remedies; histamine H2 receptor antagonists; hormones; hormonolytics; hypnotics; hypocholesterolemic agents; hypoglycemic agents; hypolipidemic agents; hypotensive agents; HMGCoA reductase inhibitors; immunizing agents; immunomodulators; immunoregulators; immunostimulants; immunosuppressants; impotence therapy adjuncts; inhibitors; keratolytic agents; leukotriene inhibitors; LHRH agonists; liver disorder treatments; luteolysin agents; memory adjuvants; mental performance enhancers; metal chelators such as ethylenediaminetetraacetic acid, tetrasodium salt; mitotic inhibitors; mood regulators; mucolytics; mucosal protective agents; muscle relaxants; mydriatic agents; narcotic antagonists; nasal decongestants; neuroleptic agents; neuromuscular blocking agents; neuroprotective agents; nicotine; NMDA antagonists; non-hormonal sterol derivatives; nutritional agents, such as vitamins, essential amino acids and fatty acids; ophthalmic drugs such as antiglaucoma agents; oxytocic agents; pain relieving agents; parasympatholytics; peptide drugs; plasminogen activators; platelet activating factor antagonists; platelet aggregation inhibitors; post-stroke and post-head trauma treatments; potentiators; progestins; prostaglandins; prostate growth inhibitors; proteolytic enzymes as wound cleansing agents; prothyrotropin agents; psychostimulants; psychotropic agents; radioactive agents; regulators; relaxants; repartitioning agents; scabicides; sclerosing agents; sedatives; sedative-hypnotic agents; selective adenosine Al antagonists; serotonin antagonists; serotonin inhibitors; serotonin receptor antagonists; steroids, including progestogens, estrogens, corticosteroids, androgens and anabolic agents; smoking cessation agents; stimulants; suppressants; sympathomimetics; synergists; thyroid hormones; thyroid inhibitors; thyromimetic agents; tranquilizers; tooth desensitizing agents; tooth whitening agents such as peroxides, metal chlorites, perborates, percarbonates, peroxyacids, and combinations thereof; unstable angina agents; uricosuric agents; vasoconstrictors; vasodilators including general coronary, peripheral and cerebral; vulnerary agents; wound healing agents; xanthine oxidase inhibitors; and the like.

Effective amount: The amount of an active agent (alone or with one or more other active agents) sufficient to induce a desired response, such as to prevent, treat, reduce and/or ameliorate a progressive degenerative disorder. Effective amounts of an active agent, alone or with one or more other active agents, can be determined in many different ways, such as assaying for a reduction in of one or more signs or symptoms associated with the condition, such as an uncontrolled inflammatory response condition, in the subject or measuring the level of one or more molecules associated with the condition to be treated.

Hydrogel: A water-swellable polymeric matrix that can absorb a substantial amount of water to form elastic gels. The matrix is a three-dimensional network of macromolecules held together by covalent or non-covalent crosslinks. Upon placement in an aqueous environment, dry hydrogels swell to the extent allowed by the degree of cross-linking.

Hydrophilic: A polymer, substance or compound that is capable of absorbing more than 10%/w of water at 100% relative humidity (rh).

Hydrophobic: A polymer, substance or compound that is capable of absorbing no more than 1%/w of water at 100% relative humidity (rh).

Hygroscopic: A polymer, substance or compound that is capable of absorbing more than 20 wt % of water at 100% relative humidity (rh).

Inhibiting a condition: Reducing, slowing, or even stopping the development of a condition, for example, in a subject who is at risk of developing or has a particular condition, such as a progressive genetic disease.

Interferon-type I: a large group of interferon proteins that bind to interferon receptors and regulate the activity of the immune system.

Lipophilic: A substance or compound that has an affinity for a non-polar environment compared to a polar or aqueous environment.

Localized application: The application of an active agent in a particular location in the body.

MicroRNAs (miRNAs): Short, highly conserved small noncoding RNA molecules naturally occurring in the genomes of plants and animals. miRNAs are 17-27 nucleotides long and regulate posttranscriptional mRNA expression, typically by binding to the 3′ untranslated region (3′-UTR) of the complementary mRNA sequence, resulting in translational repression and gene silencing. miRNAs function in tumor suppression as oncogenes, and altered expression of particular miRNAs has been implicated in the onset and development of cancer.

Multiplex Analysis: Any analysis of two or more analytes in a sample, wherein each analyte is different from one another. The methods disclosed herein may include multiplex analysis of 2 or more, 5 or more, 10 or more, 50 or more, 100 or more, 500 or more or 1000 or more analytes in a sample.

Oil: Any fatty substance that is in liquid form at room temperature (25° C.) and at atmospheric pressure (760 mmHg). An oily phase in a pharmaceutical composition may comprise at least one polar or apolar hydrocarbon-based oil.

Parenteral: a type of administration that includes subcutaneous injections, intravenous, intramuscular, intrasternal injection or infusion techniques. Compositions for parenteral injection comprise pharmaceutically acceptable sterile aqueous or nonaqueous solutions, dispersions, suspensions or emulsions as well as sterile powders for reconstitution into sterile injectable solutions or dispersions prior to use.

Pathogen: An infectious agent capable of invading a host, which is transmitted through the air, sex, blood, and other bodily fluids, or through the fecal-oral route. Common pathogens include viruses, such as the human immunodeficiency virus (HIV) and hepatitis C; bacteria; fungi, such as yeast, mold, and mushrooms; and parasites, such as protozoa, helminths, and ectoparasites.

Permeation Enhancer: A natural or synthetic molecule that facilitates the transport of co-administered active agents across biological membranes.

pH Modifier: A molecule or buffer used to achieve desired pH control in a formulation. Exemplary pH modifiers include acids (e.g., acetic acid, adipic acid, carbonic acid, citric acid, fumaric acid, phosphoric acid, sorbic acid, succinic acid, tartaric acid, basic pH modifiers (e.g., magnesium oxide, tribasic potassium phosphate), and pharmaceutically acceptable salts thereof.

Pharmaceutically acceptable carriers: The pharmaceutically acceptable carriers useful in this disclosure are conventional. Remington's Pharmaceutical Sciences, by E. W. Martin, Mack Publishing Co., Easton, Pa., 19th Edition (1995), describes compositions and formulations suitable for pharmaceutical delivery of the compositions herein disclosed. The nature of the carrier can depend on the particular mode of administration being employed. For instance, parenteral applications usually include pharmaceutically and physiologically acceptable fluids such as water, physiological saline, balanced salt solutions, aqueous dextrose, glycerol or the like as a vehicle. In addition to biologically-neutral carriers, parenteral compositions may also contain minor amounts of non-toxic auxiliary substances, such as wetting or emulsifying agents, preservatives, and pH buffering agents and the like.

Proinflammatory cytokines: cytokines produced predominantly by activated macrophages and involved in the up-regulation of inflammatory reactions. Exemplary proinflammatory cytokines include, but are not limited to, IL-1β, IL-6, and TNF-α. IL-1β is released primarily by monocytes and macrophages during cell injury, infection, invasion, and inflammation.

Subject: A living multi-cellular vertebrate organism, a category that includes human and non-human mammals, as well as birds (such as chickens and turkeys), fish, and reptiles. Exemplary subjects include mammals, such as human and non-human primates, rats, mice, dogs, cats, rabbits, cows, pigs, goats, horses, and the like.

Surface or Body Surface: A surface located on the human body or within a body orifice. Thus, a “body surface” includes, by way of example, skin, teeth, skin or mucosal tissue, including the interior surface of body cavities that have a mucosal lining.

Topical administration: Delivery of an active agent to a body surface, such as, the skin or mucosa, as in, for example, topical drug administration in the prevention or treatment of various skin disorders.

Toxic agent: An agent or substance that can produce an adverse biological effect. A toxic agent may be chemical, physical, or biological in nature. Toxic agents include, but are not limited to, inorganic substances such as lead, mercury, hydrofluoric acid, cyanide, and chlorine gas, organic compounds such as alcohol, radiations, coal dust, asbestos fibers, finely divided silicon dioxide, plant and pathogen toxins, snake venom, lithium and abused substances, such as marijuana and cocaine.

Transdermal: A route of administration by which active ingredients are delivered across the skin for systemic distribution. Examples include transdermal patches for drug delivery.

Under conditions sufficient to: A phrase that is used to describe any environment that permits the desired activity.

Water-Insoluble: A polymer, compound or composition with a solubility in water of less than 5%/w, less than 3%/w, or less than 1%/w, as measured in water at 20° C.

Water-Swellable: A polymer, substance or compound, that may absorb an amount of water greater than at least 25%/w of its own weight, or greater than at least 50%/w, upon immersion in an aqueous medium.

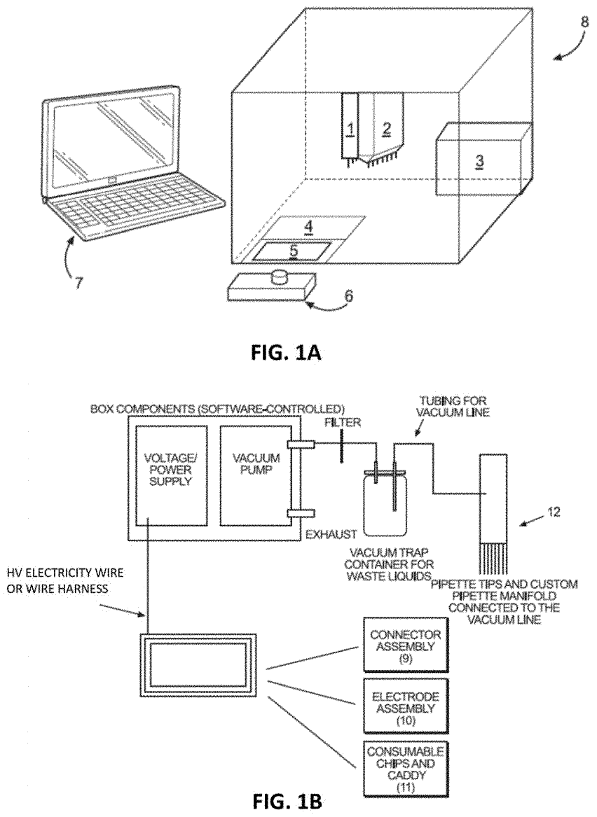

Referring now to FIGS. 1A and 1B, the figures show a diagram showing an example robot configuration (FIG. 1A) and the assay sub-unit (FIG. 1B) of an automated analyte detection and quantification system with direct sampling capabilities. The liquid handling robot may include a frame 8 for holding the robotic components. The robot may include a multichannel liquid-handling pipette 1, a vacuum arm with removable pipette tips 2, integrated components 3 (e.g., power supply and vacuum pump), an open position for connector assembly 4, position for electrode assembly 5, an imaging unit 6 (which may be integrated with the robot, or and external imaging unit), and an associated computer 7.

With regard to FIG. 1B, the sub-unit occupies one position within the “deck” of the robot layout, whereas reagents, pipette tips, or other consumables occupy other areas within the robot layout. The box and internal components are controlled via a computer and software. Communications may be in a wired or wireless format. The vacuum part 12 may designed to fit to a liquid handling control arm. The arm may move in 3 dimensions (e.g., in an x, y, z space) to remove liquid from wells. The vacuum part may have multiple tips, such as 8, 12, 16 or hundreds of tips.

The pipettor of the liquid handling robot travels back and forth between the sub-unit and other locations on the robot deck and carries out pre-programmed assay functions. Liquids are delivered to the wells (or micro-wells) within the assay consumables, which are placed within the assay sub-unit. All assay functions are carried out via the laptop computer shown on the far left in the robot layout. The sub-unit may include a connector assembly 9, electrode assembly 10 and a consumable chips & caddy 11.

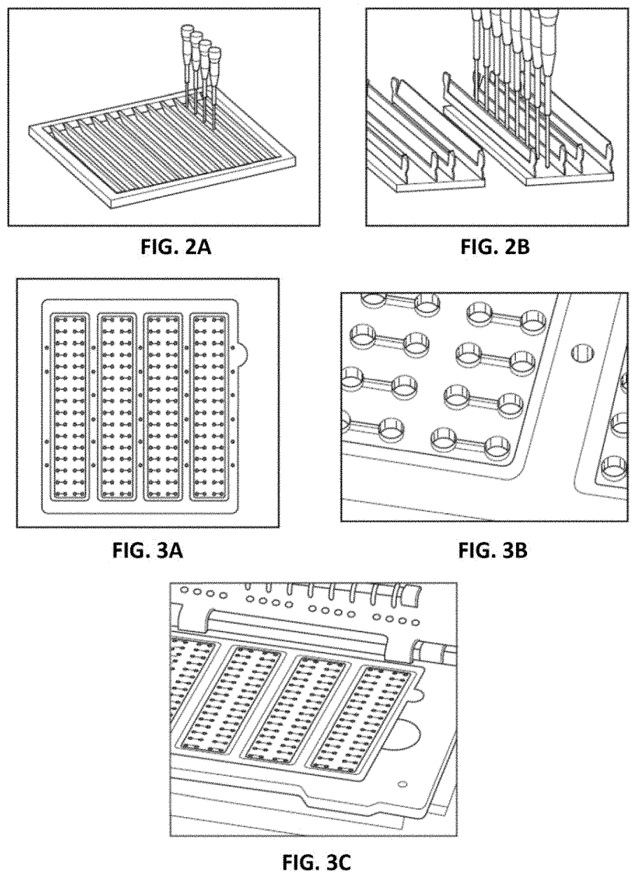

Referring now to FIGS. 2A and 2B, the figures show delivery of consumables into sample wells of a chip caddy by individual pipette tips, which are guided and directed by the liquid handling robot. Electrode rails, which run diagonally in the image, do not interfere with the liquid delivery to the wells.

Referring now to FIGS. 3A, 3B and 3C, the figures show four assay chips in a frame that can accommodate up to 128 samples at one time. The example chip caddy of FIG. 3A may hold four assay chips. The chip caddy is compatible with most biological buffers and chemicals, so chips can be installed to the caddy and stored in wet conditions. Each well in the customized assay chip has a diameter of approximately 2 mm and can hold about 2.5 μl of volume. The assay chips are seated within the assay sub-unit. For example, in a 128 sample chip caddy, there would be a total of 256 wells. The 256 wells may be 2 mm sized. A corresponding number of electrodes would be used to apply voltage into the wells. In one example, considering the wells are 2 mm, electrodes may be in 0.5 mm and pipette tips are 0.07 mm.

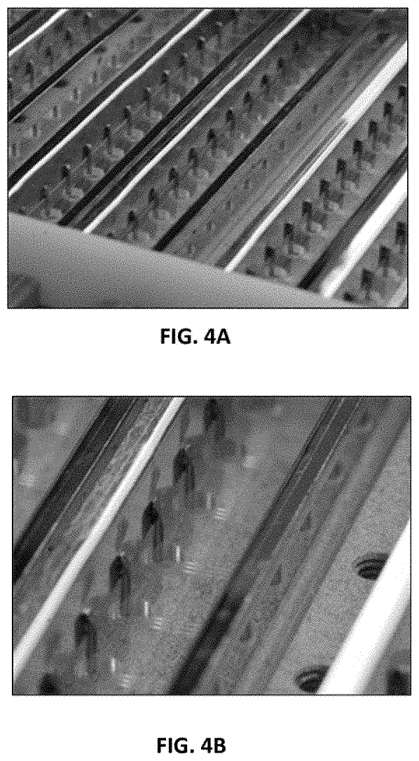

Referring now to FIGS. 4A and 4B, the figures provide a close-up view of the electrodes, which are a part of the electrode assembly and transmit electricity from the voltage power supply to the fluid-filled wells. The position of the electrodes in the system does not interfere with the liquid delivery from pipette tips.

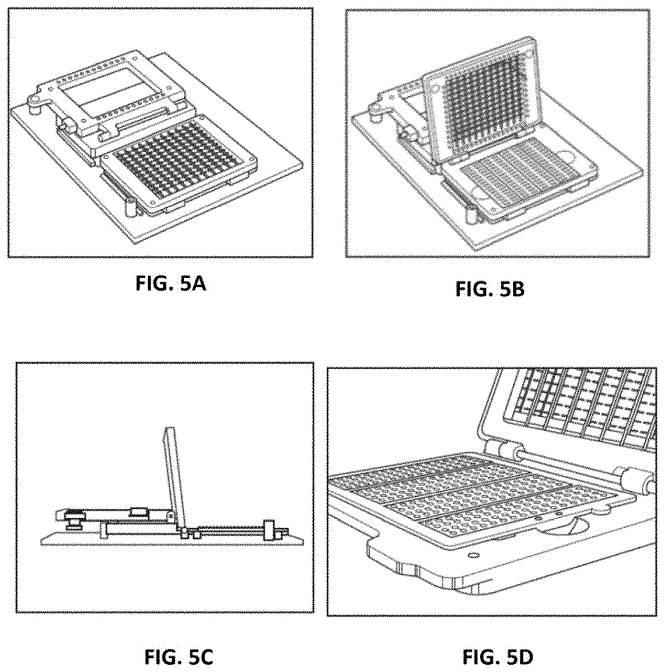

Referring now to FIGS. 5A, 5B, 5C and 5D, the figures provide a view of the connector assembly (A), and electrode assembly (B, C) in their open positions. When these assemblies are closed, a hinged frame containing the electrodes makes contact with a hinged electrical connector in the connector assembly, which applies voltage through a series of conductive pins. The consumable chip is housed at the bottom of the assembly (5D).

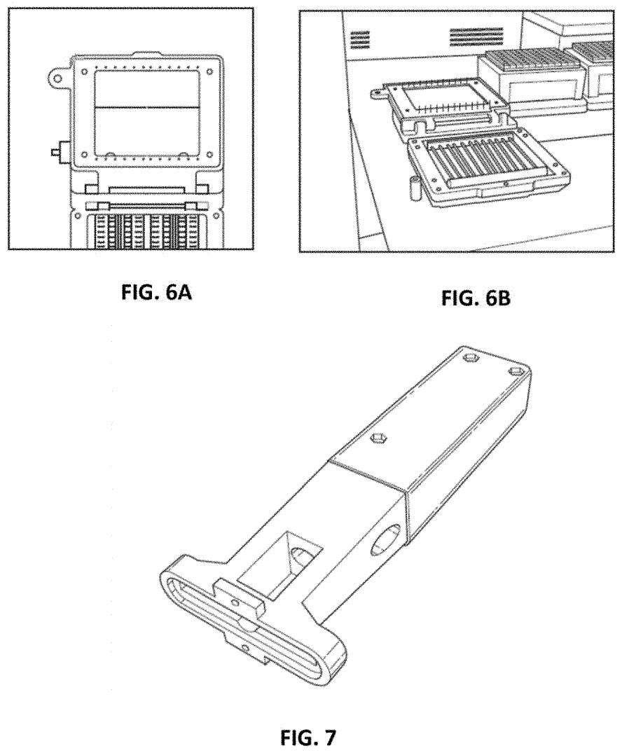

Referring now to FIGS. 6A and 6B, the figures show the conductive pins, which are integral components of the connector assembly. These pins direct voltage from the power supply cable onto the electrode rails.

Referring now to FIG. 7, the figure shows an example of a vacuum arm custom-designed to fit the liquid handling robot. A set of removable pipette tips can be attached to the bottom of the vacuum arm.

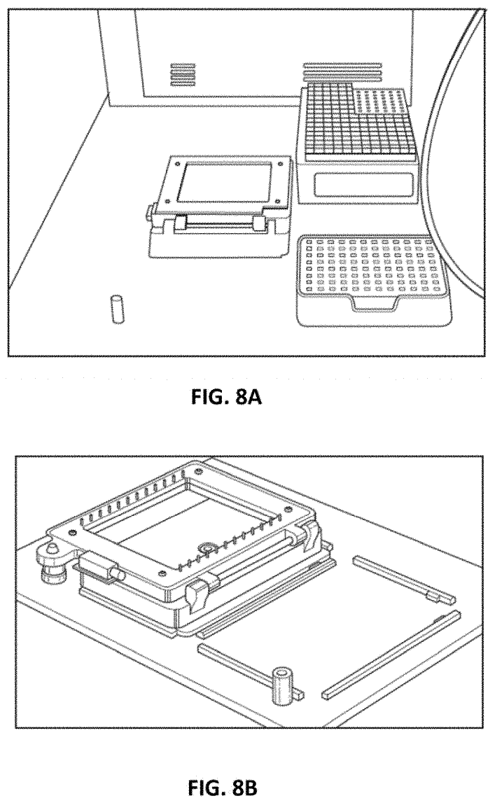

Referring now to FIGS. 8A and 8B, the figures show the connector assembly in the open position.

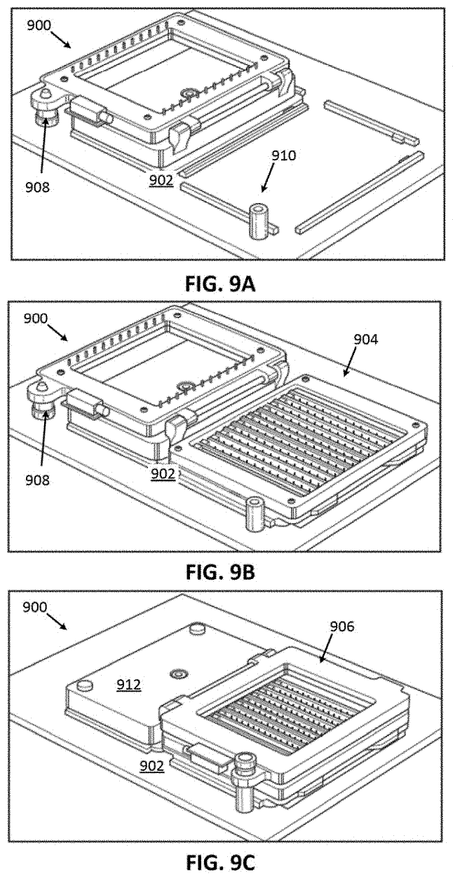

Referring now to FIGS. 9A, 9B and 9C, the figures show the connector assembly (9A), and the electrode assembly (9B) underneath the connector assembly, once the electrode assembly and connector assembly are closed and tightened (9C). The apparatus 900 may have a base 902 with a section or portion of the base 902 configured to receive or hold a chip caddy. The apparatus 900 may include a hingedly attached electrode assembly 904 attached to a portion of the apparatus 900. The apparatus may have a hingedly attached lid 906 that may be secured via a screw mechanism 908 with a post 910. The apparatus may have a raised bed 912 where the electrode assembly 904 may rest upon when in the open position.

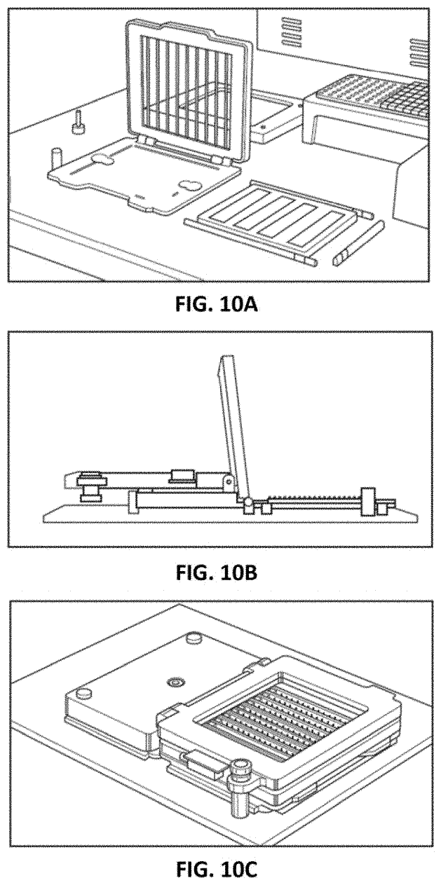

Referring now to FIGS. 10A, 10B and 10C, the figures show the electrode assembly (A, B) in the open position, and the chip caddy (C), which is placed in the electrode assembly. Once the electrode assembly lid is closed, all electrodes are precisely positioned inside the corresponding wells of the assay chips and the electrical connectors are in contact with the electrode rails.

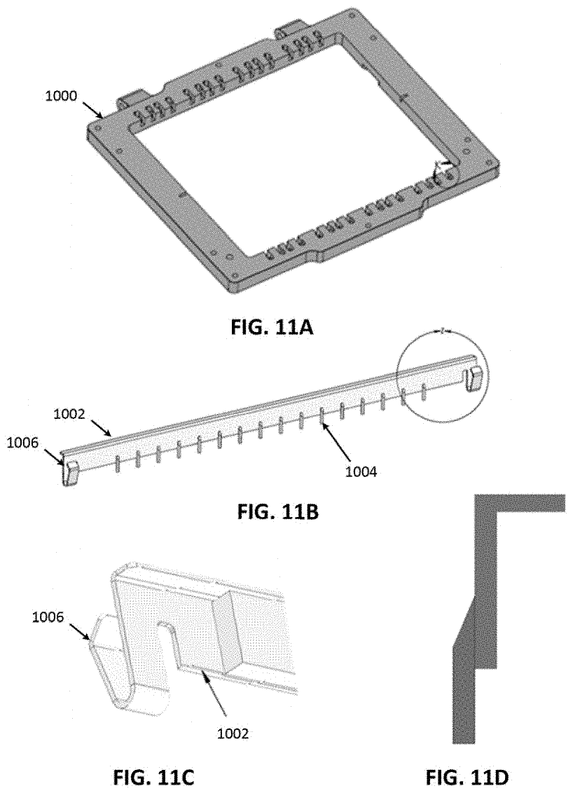

Referring now to FIGS. 11A, 11B, 11C, and D the figures show the electrode frame 1100 and electrode rails 1102. The electrode rails have electrode tips 1104 spaced on the bottom portion of the electrode rail 1102. The electrode rail 1102 has end portions 1106 that clip the rail into position into frame 1100. FIG. 11D shows an example cross-sectional view of a portion of the electrode rail and an electrode tip.

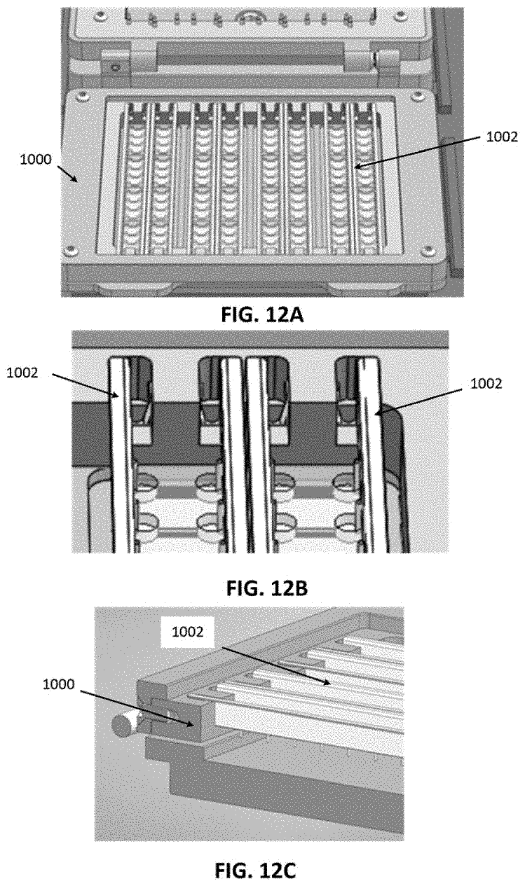

Referring now to FIGS. 12A-12C, the figures show the electrode frame 1100 and electrode rails 1102. In the example, the insulating electrode frame holds 16 electrode rails. Spring mechanism enables easy installation and removal of the electrode rails. FIG. 12C illustrates the electrode frame 1100 with a detailed cross-sectional view of the location on which the electrode rails 1100 are positioned, and the spring mechanism which pushes the electrode rail in the electrode frame.

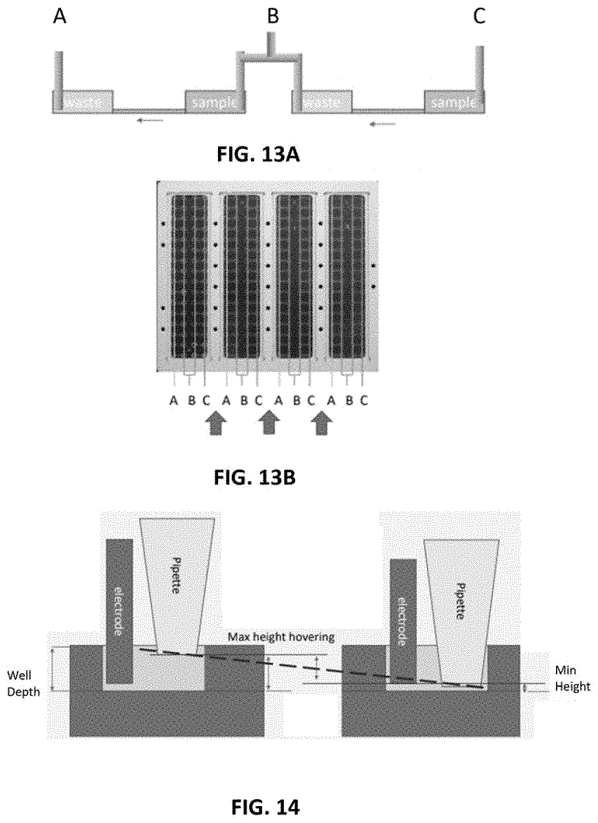

Referring now to FIGS. 13A and 13B, the figures show an example of electrodes placed in the wells of an assay chip. One electrode of a first electrode rail is placed in the waste well on the left side of the diagram, and a second electrode of a second electrode rail is placed in the sample well on the left side of the diagram. One electrode of a third electrode rail is placed in the waste well on the right side of the diagram, and a fourth electrode of a fourth electrode rail is placed in the sample well on the right side of the diagram. As between the first and second electrode rails there is applied a voltage differential. As between the third and fourth electrode rails there is applied a voltage differential.

In the example, a first voltage is applied to the first electrode rail A of a predetermined value. A second voltage is applied to the second and third electrode rails B of a predetermined value. A conductive circuit connects the two middle (second and third) electrode rails. A third voltage is applied to the fourth electrode rail C. FIG. 13B shows that there is a gap between electrode rails between the assay chips.

Referring now to FIG. 14, the figure provides a detailed view of the electrodes. The electrodes are angled at the top to prevent collisions with the pipette tips during movement.

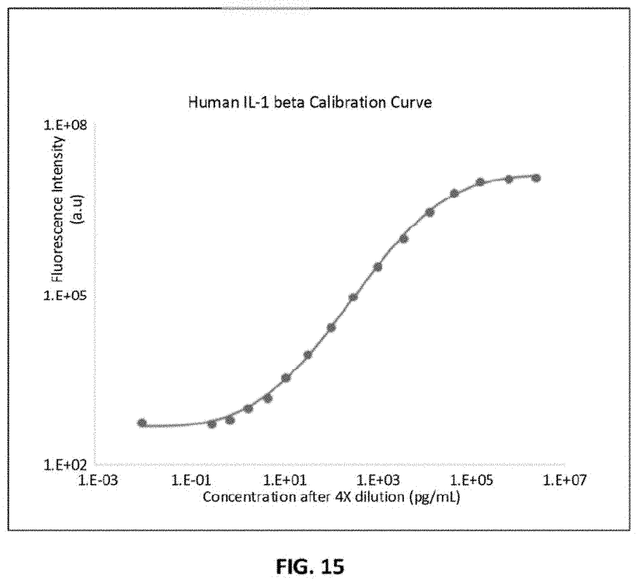

Referring now to FIG. 15, the figure shows the standard curve for the human IL-1 Beta assay. Recombinant human IL1B was spiked into assay diluent at predetermined concentrations and the obtained calibrators were introduced into the disclosed system. 2.5 μl of each calibrator was utilized within each sample well. The standard curve shows a broad dynamic range (5.5 log) with 1.9 pg/ml sensitivity.

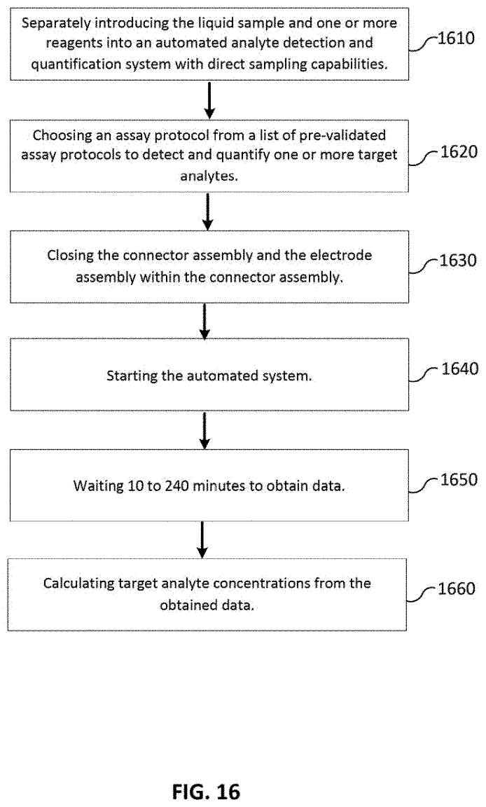

Referring now to FIG. 16, the figure illustrates a method of an automated method for singleplex and multiplex detection and quantification of one or more analytes in a liquid sample. The method begins with separately introducing the liquid sample and one or more reagents into an automated analyte detection and quantification system with direct sampling capabilities (1610). The automated analyte detection and quantification system comprises a custom-designed automated liquid handling robot having microliter pipetting capabilities and programmed to deliver, add, aspirate or remove liquids to and from sample wells at defined time intervals or in predetermined conditions, and a system comprising a conductive connector assembly, an electrode assembly, a vacuum pump, a programmable, software-controlled voltage power supply and optionally an imaging system. The method continues with choosing an assay protocol from a list of pre-validated assay protocols to detect and quantify one or more target analytes (1620); closing the connector assembly and the electrode assembly within the connector assembly (1630); starting the automated system (1640); waiting 10 to 240 minutes to obtain data (1650); and calculating target analyte concentrations from the obtained data (1660).

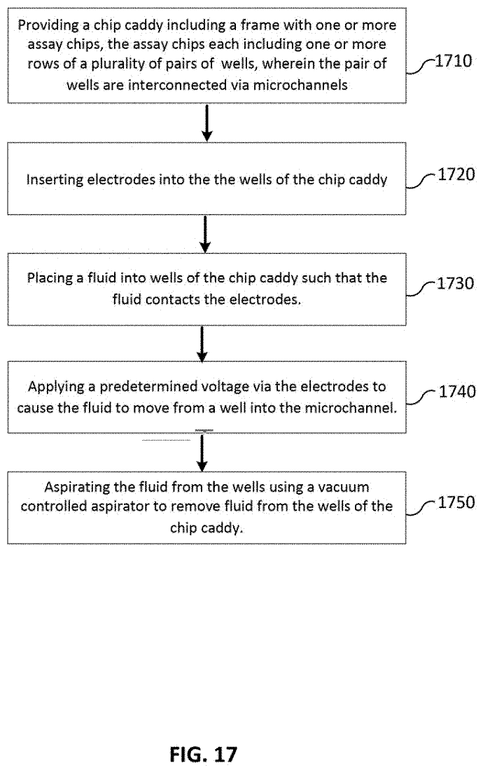

Referring now to FIG. 17, the figure illustrates a method of processing a fluid having sample molecules. The method beings with providing a chip caddy including a frame with one or more assay chips, the assay chips each including one or more rows of a plurality of pairs of wells, wherein the pair of wells are interconnected via channels (1710). Electrodes may be placed into the wells of the chip assays (1720), or the wells may have electrodes disposed within the body chip assay. A fluid, including sample molecules, is placed into wells of the chip caddy such that the fluid contacts the electrodes (1730). For example, a fluid may be placed into wells of the assay chips using a robotic controlled pipettor, having multiple pipettor tips, such that the fluid contacts an electrode positioned within the well. A predetermined voltage via the electrodes is applied to cause the fluid to move from a well into the channel. (1740). The fluid is aspirated from the wells using a vacuum controlled aspirator to remove fluid from the wells of the chip caddy (1750). Kit for Rapid and Highly Efficient Multiplex Analyte Detection and Quantification

Quick and accurate detection and quantification of target analytes and biomarkers in biological samples is essential for disease prevention strategies, diagnosis, and therapies. Most immunoassays are laborious and time-consuming, have multiple steps, and require hands-on user intervention.

Provided herein are kits for automated, pre-programmed, rapid and accurate singleplex or multiplex analyte detection and quantification in liquid samples.

The disclosed kits may include one or more of a chip caddy, consumable assay chips, a clamshell-style electrode assembly, an connector assembly, cables, a voltage power supply, a vacuum pump, a vacuum trap, and custom-designed fluid delivery and aspiration manifolds fitting different size liquid handling robot arms, and may further comprise one or more buffers, reagents and instructions for use.

These components are configured to fit different automated systems for singleplex or multiplex detection and quantification of macromolecules, and may be connected to different types of automated imagers. All components of the kit can be installed in only one direction and self-align: the assay consumables are placed into the electrode assembly, which fits under the connector assembly, which is then locked with fitting screws or a latch lock. Therefore, no training or expertise by the user is required.

Moreover, the disclosed components of the kits provided herein are configured to be used for a large number of tests, such as immunoassays, nucleic acid tests, clinical diagnostics, biomarker detection, and proteomic profiling, for the detection and quantification of proteins, peptides, antibodies, nucleic acids, biomarkers, hormones, metabolites, carbohydrates and lipids of interest, in liquid samples. Liquid samples may vary in volume from about 0.2 μl to about 1000 μl.

The disclosed components of the kits provided herein are configured to connect to different types of automated imagers. Suitable automated imagers may comprise a LED or laser-induced fluorescence imaging reader equipped with features such as a fluorescence excitation source, optical filters, a photon measurement system, such as a camera or a photomultiplier tube system, objective lenses, systems for autofocus, auto-exposure, light intensity active monitoring and regulation, and automated image analysis and reporting systems.

The chip caddy contains the consumable assay chips. These assay consumables may be single use chips or reusable chips. The consumable chips are configured to contain wells designed to accept multiple samples and reagents for multiplex analyte detection and quantification.

The caddy is compatible with most biological buffers and chemicals, such that the assay chips can be installed to the caddy and stored in wet conditions. The chip caddy may contain 1 or more assay chips. Each assay chip may contain 2 sample wells, and each chip caddy may contain 16 sample wells, 64 sample wells, 256 sample wells, 640 sample wells, 1280 sample wells, 3200 sample wells, or 6400 sample wells. Each well has a diameter from about 1 mm to about 5 mm, or from about 1.5 mm to about 3 mm. Two or more wells may be connected via channels to allow for electric field-guided migration of reagents.

The electrode assembly houses a hinged precision electrode interface, which comprises multiple electrode rails. The electrode assembly comprises a bottom metal component housing a spring mechanism configured to align a chip caddy within the electrode assembly, and a top lid comprising an insulating electrode frame holding the electrode rails. The electrode rails are configured to be straight and aligned flat and parallel to the chip caddy, such that all electrodes are positioned properly at the edge of each well.

The electrode assembly is configured to be in either an open or closed position, and it has a specific configuration, such that it is configured to connect with the connector assembly. The electrode assembly can be washed, bleached, disinfected and reused as needed.

The conductive connector assembly comprises a lid and a printed circuit board (PCB) interface. The electrode connector assembly is configured to interface with the electrode assembly and transmit electricity to the electrode rails within the electrode assembly, while providing space for liquid handling access to the assay chips. Once the connector assembly and the electrode assembly are closed into the appropriate position, each electrode in the electrode rails is configured to sit on the edge of each well and to receive electricity through the connector assembly. Each electrode may have a thickness between 0.1 mm and 1 mm, or between 0.3 mm and 0.7 mm. In addition, each electrode is a laser-welded platinum electrode comprising an angled top to allow contact with the liquid in the wells and prevent collusion with automated microtips delivering or aspirating liquids to or from the wells. The connector assembly and electrode assembly are configured to hold the consumable chips in place and deliver and maintain electrical conductivity within all wells simultaneously with millimeter or sub-millimeter spatial accuracy.

The voltage power supply may comprise from one to ten independent outputs for single or multiple connections and deliver a voltage from 0 to 5,000 volts.

The components of the disclosed kits, including the vacuum system and the voltage power supply, are configured to be integrated and connected to any software and imaging system linked to any automated system for singleplex or multiplex detection and quantification of macromolecules, to enable image analysis and advanced data analysis.

The disclosed kits are configured to enable detection and quantification of one or more analytes in liquid samples using any automated analysis system. Liquid samples may include, but are not limited to, biological samples, such as blood, serum, and urine, cell suspensions, cell supernatants and lysates, plant extracts, sea water, microfilm fluids, running water, and beverages. Liquid samples may be in a volume amount from about 0.2 μl to about 1000 μl. Analytes may include, but are not limited to, proteins, peptides, antibodies nucleic acids, biomarkers, hormones, metabolites, carbohydrates and lipids, or other macromolecules of interest. Suitable detection methods include, but are not limited to, immunoassays, nucleic acid tests, clinical diagnostics, biomarker detection, and proteomic profiling.

The components of the disclosed kits may be used with any automated liquid handling system to enable application of directional electric fields to electrokinetically and sequentially transport samples and/or reagents through the system. Additionally, the components of the disclosed kits are configured to allow any liquid handling robot to precisely transfer, dispense, deliver or aspirate liquids to and from sample wells at different times or in different cycles, in order to capture and bind target analytes. Capturing and binding target analytes may include, without limitations, sandwich antibody detection, enzyme-labeled antigen reaction, fluorometric detection, in situ hybridization, microarray technology, affinity binding, radioactive and colorimetric binding.

In some embodiments, the components of the disclosed kits may fit into an automated analyte detection and quantification system with direct sampling capabilities. This system automates detection and quantification workflows of macromolecules, such as proteins, peptides, antibodies, nucleic acid markers, hormones, metabolites, carbohydrates, lipids and other analytes of interest, including sample dilution, and provides complex sigmoidal plotting and curve fitting data from which the user can calculate target analyte concentrations, within 10 minutes to 4 hours time.

In some embodiments, the automated analyte detection and quantification system with direct sampling capabilities is a system in which all steps are automated and pre-programmed, such that little to no manual intervention is required. In some embodiments, the automated analyte detection and quantification system with direct sampling capabilities is a system in which not all steps are automated and pre-programmed, such that some manual intervention may be required, for example, to move the chip caddy from a first location to a second location. The automated analyte detection and quantification system integrates microscale liquid handling, biomolecular measurement assay and data readout, such that the user only controls the system via external computer or integrated touch screen. Accordingly, the disclosed system may be operated by a person with minimal lab training in an automated fashion. Moreover, the disclosed automated analyte detection and quantification system performs multiplex analysis with high efficiency and with sub-pg/ml sensitivity, thus providing a solution to the aforementioned challenges.

The disclosed system comprises an automated liquid handling robot and an assay subunit. The automated liquid handling robot is a custom-designed robot having microliter pipetting capabilities, and programmed to deliver, add, aspirate or remove liquids from sample wells at defined time intervals or in pre-determined conditions. The liquid handling robot is capable of automatically carrying out all necessary sample preparation steps before an assay, such as reagent mixing and sample dilution.

The automated liquid handling robot comprises a custom-designed arm comprising an aspiration manifold configured to be connected to a vacuum line. The size of the manifold may be varied to adjust for attachment of macrotips or microtips, such that the robot delivers or aspirates reagents, buffers, or the like into sample wells as needed, with millimeter or sub-millimeter accuracy.

The assay subunit comprises the conductive electrode connector assembly comprising a lid and a printed circuit board (PCB) interface, a clamshell-style electrode assembly configured to fit underneath and connect to the electrode connector assembly and to hold consumable assay chips, a vacuum pump, and a programmable voltage power supply connected to the connector interface. The electrode assembly houses a hinged precision electrode interface, which comprises multiple electrode rails. All components of the disclosed kits can be installed in only one direction and self-align: the assay chips are placed into the electrode assembly, which fits in place against the connector assembly, which is then locked with fitting screws or a latch lock. Therefore, no training or expertise by the user is required.

The system may further comprise an automated imager. The automated imager may be placed directly underneath the assay subunit or it may be a separate unit. The automatic imager may comprise a fluorescence imaging reader equipped with features such as a fluorescence excitation channels, optical filters, a photon measurement system such as a camera or photomultiplier tube system), objective lenses, an autofocus system, auto exposure, light intensity monitoring/regulation systems, and automated image analysis and reporting systems.

The voltage power supply may comprise one to ten independent outputs for single or multiple connections and deliver a voltage from 0 to 5,000 volts. The software is configured to integrate and connect the liquid handling robot, the vacuum system, and the voltage power supply, to fully automate the assay running steps and to enable image analysis and advanced data analysis. The power supply for example, may have 8 independent channels all of which can be operated independently. The channels can be used to apply voltage to the respective electrode assemblies. In one embodiment, the voltage power supply may have a voltage in the 0-1500V range with a resolution of +/−50mv; current of a 12 mA total, 10 mA max per channel with a 500 nA resolution.

When an imaging system is integrated with the body of the robot, the software is configured to connect the liquid handling robot, the vacuum system, the voltage power supply and the imaging system, to fully automate the assay running and imaging steps, and enable image analysis and advanced data analysis.

The disclosed automated system is configured to detect the presence of one or more analytes of interest in a liquid sample and quantify detected amounts of one or more analytes within a period of time from about 10 minutes to about 4 hours. Liquid samples may include, but are not limited to, biological samples, such as blood, serum, and urine, cell suspensions, cell supernatants and lysates, plant extracts, sea water, microfilm fluids, running water, and beverages. Analytes may include, but are not limited to, proteins, peptides, antibodies, nucleic acids, biomarkers, hormones, metabolites, carbohydrates and lipids, or other macromolecules of interest. Suitable detection methods include, but are not limited to, immunoassays, nucleic acid tests, clinical diagnostics, biomarker detection, and proteomic profiling.

The disclosed automated system is configured to allow one or more liquid samples and one or more reagents to be introduced separately and at different times into the system. Liquid samples may be in a volume amount from about 0.2 μl to about 1000 μl.

The disclosed automated system is configured to apply directional electric field to the electrode assembly, such that one or more reagents are electrokinetically and sequentially transported through the system to the one or more samples. The disclosed automated system is also configured to allow the liquid handling robot to precisely transfer, dispense into, deliver to or aspirate from different samples one or more reagents at different times or in different cycles, in order to capture and bind target analytes. Capturing and binding target analytes may include, without limitations, sandwich antibody detection, enzyme-labeled antigen reaction, fluorometric detection, in situ hybridization, microarray technology, affinity binding, radioactive and colorimetric binding.

Thus, the kits disclosed herein provide accurate, rapid and effective detection and quantification of analytes in liquid samples.

### Example

Highly Efficient IL-1 Beta Measurements from Volume-Limited Renal Carcinoma Cells Treated with Different Drug Combinations

The goal of the study was to assess the variation of IL1 Beta concentrations in immune response to various drug/treatment combinations applied to renal carcinoma cell cultures obtained from subjects in clinical trial.

IL1 Beta (IL1B) is an Interleukin 1 family cytokine that plays an important role in inflammatory response. It is involved in cell proliferation, differentiation and apoptosis and, because of its potential to modulate acute inflammation, IL1B is a biomarker of interest for therapeutic applications and drug development safety assessments. In renal cell carcinoma, IL1B is one of the major mediators of local and systemic inflammation.

In this study, IL1B was measured for biomarker-assisted therapy. Primary tumor cells were removed via micro-biopsy from clinical trial patients undergoing treatment for renal cell carcinoma. The tumor cells were then incubated in vitro with combinations of therapeutics to determine response and impact on secreted protein biomarkers. The goal of this study was to preserve precious samples from the tumor cells and compare the efficacy of microvolume immunoassays to conventional technology.

To generate a calibration curve, recombinant human IL1B was spiked into an assay diluent at predetermined concentrations and the calibrators thus obtained were introduced into an automated analyte detection and quantification system with direct sampling capabilities as provided herein. 2.5 μl of each calibrator was utilized within each sample well. As shown in FIG. 15, results demonstrated a broad dynamic range (5.5 log) with 1.9 pg/ml sensitivity. The R² of the 5-parameter sigmoid fit was 0.9994. The disclosed system did not exhibit any hook effect artifacts at high target concentrations (data not shown). The lack of artifacts and the broad dynamic range make the automated analyte detection and quantification system with direct sampling capabilities as provided herein suitable for quick, highly efficient detection and quantification of analytes, as it offers a simple one-step assay, with minimal or no involvement of the user and with no need to repeat the analysis multiple times.

The available sample volume that was tested for each condition was 10 μl. Of the 10 μl sample, a 2.5 μl aliquot was diluted 4 times into the assay diluent. From the resulting 10 μl of total diluted sample, 2.5 μl were loaded into the sample wells. The remaining 7.5 μl of the original sample were preserved for future assays. The assay was completed in less than an hour from start to finish in a hands-free, fully automated manner. The data presented here were automatically calculated using analysis software.

### FURTHER KIT EXAMPLES

Example 1A. A kit for automated and pre-programmed singleplexed and multiplexed detection and quantification of one or more analytes in a liquid sample, wherein the kit comprises one or more components, and wherein the one or more components comprise a chip caddy, consumable assay chips, an electrode assembly, an electrical connector assembly, one or more cables, a voltage supply, a vacuum pump, a vacuum trap, custom-designed manifolds, one or more buffers, reagents and instructions for use.

Example 2A. The kit of example 1A, wherein the components of the kit are configured to fit different automated systems and to allow for singleplex or multiplex detection and quantification of macromolecules, and to be connected to different automated imagers.

Example 3A. The kit of example 2A, wherein the components of the kit are configured to subject a liquid sample to an immunoassay, nucleic acid test, clinical diagnostic tests, biomarker detection, and/or multiplexed proteomic profiling.

Example 4A. The kit of example 3A, wherein the components of the kit are configured to subject a liquid sample to target analyte detection and quantification.

Example 5A. The kit of example 4A, wherein the target analyte is one or more of a protein, peptide, antibody, nucleic acid, biomarker, hormone, metabolite, carbohydrate or lipid.

Example 6A. The kit of example 5A, wherein the liquid sample is in a volume amount from about 0.2 μl to about 1000 μl.

Example 7A. The kit of example 6A, wherein the automated imagers comprise one or more of a fluorescence excitation source, an optical filter, a photon measurement system, an objective lens, a system for autofocus, auto exposure, or light intensity monitoring and regulation, and an automated image analysis and reporting system.

Example 8A. The kit of example 7A, wherein the chip caddy contains 1 or more consumable assay chips.

Example 9A. The kit of example 8A, wherein the consumable chips are single use chips.

Example 10A. The kit of example 9A, wherein the consumable chips are reusable chips.

Example 11A. The kit of example 8A, wherein the consumable chips comprise 2 sample wells, 16 sample wells, 64 sample wells, 256 sample wells, 640 sample wells, 1280 sample wells, 3200 sample wells, or 6400 sample wells.

Example 12A. The kit of example 11A, wherein each well has a diameter from about 1 mm to about 5 mm, or from about 1.5 mm to about 3 mm, and wherein two or more wells are interconnected via channels.

Example 13A. The kit of example 1A, wherein the electrode assembly is configured to fit in place under the connector assembly lid and to hold consumable assay chips.

Example 14A. The kit of example 13A, wherein the electrode assembly comprises a hinged precision electrode interface connectable to the programmable voltage power supply.

Example 15A. The kit of example 14A, wherein the voltage power supply comprises from one to ten independent outputs.

Example 16A. The kit of example 15A, wherein the electrode assembly comprises a bottom component housing a spring mechanism configured to align a chip caddy within the electrode assembly, and a top lid comprising an insulating electrode frame holding electrode rails.

Example 17A. The kit of example 16A, wherein the electrode rails are configured to be straight and aligned flat and parallel to the chip caddy.

Example 18A. The kit of example 17A, wherein the electrode assembly is removable from the connector assembly.

Example 19A. The kit of example 18A, wherein the electrode assembly is washable, bleachable, disinfectable and reusable.

Example 20A. The kit of example 19A, wherein the connector assembly comprises a lid and a printed circuit board (PCB) interface.

Example 21A. The kit of example 20A, wherein the connector assembly is attachable to an automated liquid handling robot's base and it is configured to transmit electricity to the electrode rails within the electrode assembly.

Example 22A. The kit of example 21A, wherein each electrode has a thickness between 0.1 mm and 1 mm, or between 0.3 mm and 0.7 mm.

Example 23A. The kit of example 22A, wherein each electrode is a laser-welded platinum electrode comprising an angled top.

Example 24A. The kit of example 23A, wherein the liquid handling robot, the vacuum system, the voltage power supply and the imaging system are configured to be integrated and connected by a custom software.

Example 25A. The kit of example 1A, wherein the custom-designed manifolds are configured to be connectable to a vacuum line and for macro tip or micro tip attachment.

Example 26A. The kit of example 25A, wherein the custom-designed manifolds are configured to be attached to an automated liquid handling robot to deliver or aspirate one or more assay reagents to one or more wells in the consumable chips.

Example 27A. The kit of example 1A, wherein the components of the kit are configured to fit into an automated analyte detection and quantification system with direct liquid sampling and sample dilution capabilities, and wherein the automated analyte detection and quantification system with direct liquid sampling and sample dilution capabilities comprises an automated liquid handling robot having microliter pipetting capabilities, programmed to deliver, add, aspirate or remove liquids to and from sample wells and assay chip wells at defined time intervals or in pre-determined conditions, and capable of automatically carrying out all sample preparation steps.

Example 28A. The kit of example 27A, wherein the automated liquid handling robot comprises a custom-designed arm comprising an aspiration manifold connected to a vacuum line and configured for micro tip attachment.

Example 29A. The kit of example 28A, wherein the automated analyte detection and quantification system further comprises an automated imager.

Example 30A. The kit of example 29A, wherein the automated imager is integrated into the automated analyte detection and quantification system with direct liquid sampling and sample dilution capabilities.

Example 31A. The kit of example 30A, wherein the automated imager is separate from the automated analyte detection and quantification system with direct liquid sampling and sample dilution capabilities.

Example 32A. The kit of example 30A, wherein the automatic imager comprises a fluorescence reader.

Example 33A. The kit of example 32A, wherein the custom software integrates and connects the liquid handling robot, the vacuum system, the voltage power supply and the automatic imager, are configured to be integrated and connected by a custom software.

Example 34A. The kit of example 33A, wherein the automated liquid handling robot is configured to deliver or aspirate one or more assay reagents to one or more wells in the consumable assay chips at different times or in different sequences.

Example 35A. The kit of example 34A, wherein the automated system is configured to detect the presence of one or more analytes in a liquid sample and quantify detected amounts of one or more analytes within a period of time from about 10 minutes to about 4 hours.

Example 36A. The kit of example 35A, wherein the liquid sample is one or more of a biological sample, a cell suspension, supernatant or lysate, plant extracts, seawater, a microfilm fluid, water samples, or a beverage.

Example 37A. The kit of example 36A, wherein the biological sample is blood, serum, urine, or a body fluid from a human or animal.

Example 38A. The kit of example 37A, wherein the automated analyte detection and quantification system is configured to detect and quantify one or more of a protein, peptide, antibody, nucleic acid, biomarker, hormone, metabolite, carbohydrate and lipid.

Example 39A. The kit of example 38A, wherein detection comprises one or more of an immunoassay, nucleic acid test, multiplex diagnostic test, biomarker measurement or detection, and/or proteomic profiling.

Example 40A. The kit of example 39A, wherein the automated system is configured to allow one or more liquid samples and one or more reagents to be separately and at different times introduced into the system.

Example 41A. The kit of example 40A wherein the liquid sample volume is from about 0.2 μL to about 1000 μL.

Example 42A. The kit of example 41A, wherein the automated analyte detection and quantification system is configured to apply directional electric field, such that one or more reagents are electrokinetically and sequentially transported from one well to another on the assay chips.

Example 43A. The kit of example 42A, wherein the automated analyte detection and quantification system is configured to allow a liquid handling robot to precisely transfer, dispense into, deliver to or aspirate from different samples or one or more reagents at different times or in different cycles, in order to perform assays on target analytes.

Example 44A. The kit of example 43A, wherein the assays comprise one or more of sandwich antibody detection, enzyme-labeled antigen reaction, fluorometric detection, in situ hybridization, microarray technology, affinity binding, radioactive and colorimetric binding.

It should be recognized that illustrated embodiments are only examples of the disclosed product and methods and should not be considered a limitation on the scope of the invention. Rather, the scope of the invention is defined by the following claims. We therefore claim as our invention all that comes within the scope and spirit of these claims.

### Automated System for Rapid and Highly Efficient Multiplex Analyte Detection and Quantification

Quick and accurate detection and quantification of target analytes and biomarkers in biological samples is essential for disease prevention strategies, diagnosis, and therapies. Most immunoassays are laborious and time-consuming, have multiple steps, and require hands-on user intervention.

Provided herein is an automated analyte detection and quantification system with direct sampling capabilities, which automates detection and quantification workflows of macromolecules, such as proteins, peptides, antibodies, nucleic acid markers, hormones, metabolites, carbohydrates, lipids and other analytes of interest, including sample dilution, and provides complex sigmoidal plotting and curve fitting data from which the user can calculate target analyte concentrations, within 10 minutes to 4 hours time.

In some embodiments, the automated analyte detection and quantification system with direct sampling capabilities is a system in which all steps are automated and pre-programmed, such that little to no manual intervention is required. In some embodiments, the automated analyte detection and quantification system with direct sampling capabilities is a system in which not all steps are automated and pre-programmed, such that some manual intervention may be required, such as, for example, to move the chip caddy from a first location to a second location.

The automated analyte detection and quantification system is configured to integrate microscale liquid handling, biomolecular measurement assay and data readout, such that the user only controls the system via external computer or integrated touch screen. Accordingly, the disclosed system may be operated by a person with minimal lab training in an automated fashion. Moreover, the disclosed automated analyte detection and quantification system performs multiplex analysis with high efficiency and with sub-pg/ml sensitivity, thus providing a solution to the aforementioned challenges.

The disclosed system comprises an automated liquid handling robot and an assay subunit. The automated liquid handling robot is a custom-designed robot having microliter pipetting capabilities, and programmed to deliver, add, aspirate or remove liquids from sample wells at defined time intervals or in pre-determined conditions. The liquid handling robot is additionally configured to automatically carry out all necessary sample preparation steps before an assay, such as reagent mixing and sample dilution.

The automated liquid handling robot comprises a custom-designed and manufactured arm comprising an aspiration manifold configured to be connected to a vacuum line. The size of the manifold may be varied to adjust for attachment of macrotips or microtips, such that the robot may deliver or aspirate reagents, buffers, or the like into sample wells as needed, with millimeter or sub-millimeter accuracy.

The assay subunit is a system that comprises a conductive connector assembly comprising a lid and a printed circuit board (PCB) interface, an electrode assembly configured to fit into the connector assembly and to hold consumable assay chips, a vacuum pump, and a programmable voltage power supply connected to the connector interface.

The electrode assembly houses a hinged precision electrode interface, which comprises multiple electrode rails. All components of the assay subunit can be installed in only one direction and self-align: the assay chips are placed into the electrode assembly, which fits under the connector assembly, which is then locked with fitting screws or a latch lock. Therefore, no training or expertise by the user is required.

The system may further comprise an automated imager. The automated imager may be integrated into the system, or it may be a separate unit from the system. The automatic imager may comprise a fluorescence imaging reader equipped with features, such as a microscope, excitation channels, optical filters, a photon measurement system such as a camera or photomultiplier tube system, objective lenses, an autofocus system, auto exposure, light intensity active monitoring and regulation systems, and/or an automated image analysis and reporting system.

The voltage power supply may comprise from one to ten independent outputs for single or multiple connections and it is configured to deliver a voltage from 0 to 5,000 volts. The software is configured to integrate and connect the liquid handling robot, the vacuum system, the voltage power supply and the imaging system, to enable image analysis and advanced data analysis.

The connector assembly may be fixed to a plate at the automated liquid handling robot's base, and it is configured to hold the electrode assembly and transmit electricity to the electrode rails within the electrode assembly, while providing space for liquid handling access to the assay chips.

The electrode assembly comprises a bottom metal component housing a spring mechanism configured to align a chip caddy within the electrode assembly, and a top lid comprising an insulating electrode frame holding the electrode rails. The electrode rails are configured to be straight and aligned flat and parallel to the chip caddy, such that all electrodes are positioned properly at the edge of each well.

The electrode assembly is configured to be in either an open or closed position, and it is configured to connect with the connector assembly. The electrode assembly can be washed, bleached, disinfected and reused as needed.

The chip caddy contains the consumable assay chips. These consumable assay chips may be single use chips or reusable chips. The consumable assay chips are configured to contain wells designed to accept multiple samples and reagents for multiplex analyte detection and quantification.

The caddy is compatible with most biological buffers and chemicals, such that the assay chips can be installed to the caddy and stored in wet conditions. The chip caddy may contain 1 or more assay chips. Each assay chip may contain 2 sample wells, and each chip caddy may contain 16 sample wells, 64 sample wells, 256 sample wells, 640 sample wells, 1280 sample wells, 3200 sample wells, or 6400 sample wells. Each well has a diameter from about 1 mm to about 5 mm, or from about 1.5 mm to about 3 mm. Two or more wells may be connected via channels to allow for electric field-guided migration of reagents. In one example, the channels may be cylindrical in shape, or other suitable shapes, such as D-shaped, square, oval, etc. The dimension of the channel may be for 0.5 micrometers to 1000 micrometers in width and/or depth. The length of the channels can be of any suitable lengths, for example from a few millimeters to a few centimeters. The automated liquid handling robot is configured to deliver or aspirate one or more assay reagents in appropriate sequence to one or more wells within the consumable chips.

Once the connector assembly and the electrode assembly within the connector assembly are closed into the appropriate position, each electrode in the electrode rails is configured to sit on the edge of each well and to receive electricity through the connector assembly. Each electrode may have a thickness between 0.1 mm and 1 mm, or between 0.3 mm and 0.7 mm. In addition, each electrode is a laser-welded platinum electrode comprising an angled top to allow contact with the liquid in the wells and prevent collisions with the microtips delivering or aspirating liquids to or from the wells.

The assay subunit is configured to hold the consumable chips in place and deliver and maintain electrical conductivity within all wells simultaneously with millimeter or sub-millimeter spatial accuracy.

The disclosed automated system is configured to detect the presence of one or more analytes of interest in a liquid sample and quantify detected amounts of one or more analytes within a period of time from about 10 minutes to about 4 hours. Liquid samples may include, but are not limited to, biological samples, such as blood, serum, and urine, cell suspensions, cell supernatants and lysates, plant extracts, sea water, microfilm fluids, running water, and beverages. Analytes may include, but are not limited to, proteins, peptides, antibodies, nucleic acids, biomarkers, hormones, metabolites, carbohydrates and lipids, or other macromolecules of interest. Suitable detection methods include, but are not limited to, immunoassays, nucleic acid tests, clinical diagnostics, biomarker detection, and proteomic profiling.

The disclosed automated system is configured to allow one or more liquid samples and one or more reagents to be introduced separately and at different times into the system. Liquid samples may be in a volume amount from about 0.4.1 to about 1000μl.

The disclosed automated system is configured to apply directional electric field to the assay chips, such that one or more reagents are electrokinetically and sequentially transported from one well to the other. The disclosed automated system is also configured to allow the liquid handling robot to precisely transfer, dispense into, deliver to or aspirate from different samples one or more reagents at different times or in different cycles, in order to carry out sample preparation steps, or capture and bind target analytes. Capturing and binding target analytes may include, without limitations, sandwich antibody detection, enzyme-labeled antigen reaction, fluorometric detection, in situ hybridization, microarray technology, affinity binding, radioactive and colorimetric binding.

Rapid and Highly Efficient Multiplex Analyte Detection and Quantification Protocol with the Disclosed Automated System

Also provided herein are automated methods for singleplex and multiplex detection and quantification of one or more analytes in a liquid sample, which require minimal or no manual interventions. The disclosed automated methods comprise (a) separately introducing the liquid sample and one or more reagents into the disclosed automated analyte detection and quantification system with direct sampling capabilities; (b) choosing an assay protocol from a list of pre-validated assay protocols to detect and quantify one or more target analytes; (c) closing the connector assembly and the electrode assembly within the connector assembly; (d) starting the automated system; (e) waiting 10 to 240 minutes; and (f) calculating target analyte concentrations from detection and quantification data presented by the automated system.

The step of separately introducing the liquid samples and reagents into the automated analyte detection and quantification system may comprise automated dilution of the fluid samples and/or the reagents with a loading medium prior to delivery of each liquid sample and delivering each reagent into separate, inter-connected wells of the consumable assay chips by the automated liquid handling robot, and placing a chip caddy containing one or more consumable assay chips into the electrode assembly located below the connector assembly. Assay chip placement and electrode assembly may be automated and pre-programmed or performed manually.

Once the system is started, it applies a voltage difference through the conductive pins in the connector assembly to the electrode rails within the electrode assembly to generate a directional electric field between the wells and transport reagent or analyte molecules from well-to-well. The disclosed automated methods may comprise several cycles of automated fluid delivery and/or aspiration by the liquid handling robot, followed by automated electric field application to move one or more reagent or analyte molecules from well-to-well.

The chip caddy is then transported manually or in automated fashion to a reader for detection and quantification of immobilized analytes. Analyte detection may include labeling the analyte of interest with a detectable label and detecting the signal emitted by the detectable label. Detectable labels include, but are not limited to, a fluorescent label, a colorimetric label, a chemo-luminescent label, a color reagent, an enzyme-linked reagent, an antibody-linked reagent, a radiolabel or a magnetic label. Analyte quantification may include any quantitative analysis, such as advanced data analysis, display of results, composing reporting structures, validation of image-derived metrics with anatomic and physiological parameters, and the use of metrics in research, prevention, diagnosis, prognosis, and medical treatment.

Thus, the system and methods disclosed herein provide accurate, rapid and effective detection and quantification of analytes in liquid samples.

### Example

Highly Efficient IL1 Beta Measurements from Volume-Limited Renal Carcinoma Cells

Treated with Different Drug Combinations

The goal of the study was to assess the variation of IL1 Beta concentrations in immune response to various drug/treatment combinations applied to renal carcinoma cell cultures obtained from subjects in clinical trial.

IL1 Beta (IL1B) is an Interleukin 1 family cytokine that plays an important role in inflammatory response. It is involved in cell proliferation, differentiation and apoptosis and, because of its potential to modulate acute inflammation, IL1B is a biomarker of interest for therapeutic applications and drug development safety assessments. In renal cell carcinoma, 1L1B is one of the major mediators of local and systemic inflammation.

In this study, IL1B was measured for biomarker-assisted therapy. Primary tumor cells were removed via micro-biopsy from clinical trial patients undergoing treatment for renal cell carcinoma. The tumor cells were then incubated in vitro with combinations of therapeutics to determine response and impact on secreted protein biomarkers. The goal of this study was to preserve precious samples from the tumor cells and compare the efficacy of microvolume immunoassays to conventional technology.

To generate a calibration curve, recombinant human IL1B was spiked into an assay diluent at predetermined concentrations and the calibrators thus obtained were introduced into an automated analyte detection and quantification system with direct sampling capabilities as provided herein. 2.5 μl of each calibrator was utilized within each sample well. As shown in FIG. 15, results demonstrated a broad dynamic range (5.5 log) with 1.9 pg/ml sensitivity. The R² of the 5-parameter sigmoid fit was 0.9994. The disclosed system did not exhibit any hook effect artifacts at high target concentrations (data not shown). The lack of artifacts and the broad dynamic range make the automated analyte detection and quantification system with direct sampling capabilities as provided herein suitable for quick, highly efficient detection and quantification of analytes, as it offers a simple one-step assay, with minimal or no involvement of the user and with no need to repeat the analysis multiple times.

The available sample volume that was tested for each condition was 10 μl. Of the 10 μl sample, a 2.5 μl aliquot was diluted 4 times into the assay diluent. From the resulting 10 μl of total diluted sample, 2.5 μl were loaded into the sample wells. The remaining 7.5 μl of the original sample were preserved for future assays. The assay was completed in less than an hour from start to finish in a hands-free, fully automated manner. The data presented here were automatically calculated using analysis software.

Example Robotic Operation for an Assay

Step 1. The robot pipettor first picks up pipettes.

Step 2. The robot pipettor performs sample dilutions (e.g., places about a 9 μl and places into tubes). Then the robot takes 1 μl from raw samples and mixes the raw samples with the 9 μl of the diluent. The robot pipettor would repeat this process for multiple samples.

Step 3. The robot pipettor then pick up 2 μl of buffer and move to the assay chip location. Before dispensing the buffer, the robot aspirator clears up liquid from the waste wells of the chip assays. The robot pipettor then dispenses the buffer to one of the wells of the pair of wells.

Step 4. The robot pipettor repeats the steps 1-3 but for sample fluids. The robot pipettor picks up and dispenses sample into samples into the samples wells. Before dispensing the sample into the sample wells, the robot aspirator clears up liquid from the sample wells of the chip assays of the chip caddy.

Step 5. The robot pipettor then dispenses pipettor tips and parks into position. At this point, the samples and the buffer have been filled into the respect wells.

Step 6. The electrode assembly is positioned into place causing the electrodes tips to be submerged into the respective pairs of waste and sample wells. A voltage is then applied for a set period of time thereby causing a current between the fluid in the pair of wells.

Step 7. When the duration of applied voltage is completed, the robot pipettor repeat step 3. This may be done for example, three times to wash wells of the chip caddy.

Step 8. Steps 4 through 5 may be repeated to add new samples to the washed wells, and then the voltage in step 6.

Step 9. After the samples processing is done, an imager obtains images of all of the location of the pairs of wells of the chip caddy (for example, 96 locations). The digital imagery may be in two spectrums. One primary image (to show exposure), and a second image to show three to nine different time exposures (e.g, 20 ms, 400 ms, 800 ms, 1600 ms, 3200 ms.)

Step 10. The images are then transferred to a computer where software performs an analysis and generates data pertaining to the processed samples.

For each of the transfer or washing steps described above, the robotic system may perform the steps of: Step 1. The robotic pipettor picks up pipette tips. Step 2. The robotic pipettor picks up liquid. Step 3. A vacuum manifold is used to extract fluid and clean the wells. Step 4. The robotic pipettor dispenses to the cleaned wells. Step 5. The robotic pipettor discards the pipettes.

Example Robotic Operation for an Assay

In another example, the robotic system performs multiple steps.

Step 1. The robotic system performs an operation to dilute samples.

Step 2. The robotic system provides a buffer refresh to all wells of an assay chip.

Step 3. The robotic system then transfers samples to wells of the assay chip.

Step 4. The robotic system then applies a predetermined voltage the electrode rails of the assembly to transport sample into the channel interconnecting the pairs of wells.

Step 5. The robotic system washes the wells multiple times.

Step 6. The robotic system then applies a predetermined voltage to electrode rails of the electrode assembly to remove nonspecific samples from the channel.

Step 7. The robotic system washes the wells multiple times.

Step 8. The robotic system transfers primary antibody to the wells.

Step 9. The robotic system then applies a predetermined voltage to the electrode rails of the electrode assembly to transport primary antibodies into the channels.

Step 10. The robotic system then washes the wells multiple times.

Step 11. The robotic system then applies a predetermined voltage to the electrode rails of the electrode assembly to remove unbound primary antibodies from the channels.

Step. 12 The robotic system then washes the wells multiple times.

Step 13. Optionally, the robotic system then repeats steps 8-12 as needed. For example, if using a secondary antibody, steps 8-12 may be repeated.

Step 14. Obtain images of all of the location of the pairs of wells of the chip caddy, and analyzing the image to generate data.

### FURTHER EXAMPLES

Example 1B. An automated analyte detection and quantification system with direct sampling capabilities, wherein the automated analyte detection and quantification system comprises a custom-designed automated liquid handling robot having microliter pipetting capabilities and programmed to deliver, add, aspirate or remove liquids to and from sample wells at defined time intervals or in predetermined conditions, and an assay subunit system comprising a conductive connector assembly, an electrode assembly, a vacuum pump, and a programmable voltage power supply.

Example 2B. The automated analyte detection and quantification system of Example 1B, wherein the automated liquid handling robot comprises a custom-designed and manufactured arm comprising an aspiration manifold connected to a vacuum line and configured for micro tip attachment.

Example 3B. The automated analyte detection and quantification system of Example 2B, wherein the connector assembly comprises a lid and a printed circuit board (PCB) interface.

Example 4B. The automated analyte detection and quantification system of Example 3B, wherein the connector assembly is fixed to a plate at the automated liquid handling robot's base.

Example 5B. The automated analyte detection and quantification system of Example 4B, wherein the electrode assembly is configured to fit into the connector assembly and to hold consumable assay chips, and wherein the electrode assembly comprises a hinged precision electrode interface.

Example 6B. The automated analyte detection and quantification system of Example 5B, wherein the hinged precision electrode interface comprises multiple electrode rails.

Example 7B. The automated analyte detection and quantification system of Example 6B, wherein the connector assembly is configured to transmit electricity to the electrode rails within the electrode assembly.

Example 8B. The automated analyte detection and quantification system of Example 7B, wherein the electrode assembly comprises a bottom component housing a spring mechanism configured to align a chip caddy within the electrode assembly, and a top lid comprising an insulating electrode frame holding the electrode rails.

Example 9B. The automated analyte detection and quantification system of Example 8B, wherein the electrode rails are configured to be straight and aligned flat and parallel to the chip caddy.

Example 10B. The automated analyte detection and quantification system of Example 9B, wherein the electrode assembly is configured to be in open or closed position.

Example 11B. The automated analyte detection and quantification system of Example 10B, wherein the electrode assembly is removable from the connector assembly.

Example 12B. The automated analyte detection and quantification system of Example 11B, wherein the electrode assembly is configured to be washed, bleached, disinfected and reused.

Example 13B. The automated analyte detection and quantification system of Example 12B, wherein the chip caddy contains consumable assay chips.

Example 14B. The automated analyte detection and quantification system of Example 13B, wherein the consumable assay chips are single use chips.

Example 15B. The automated analyte detection and quantification system of Example 13B, wherein the consumable assay chips are reusable chips containing wells designed to accept multiple samples and carry out analyte measurement assays on multiple samples simultaneously.

Example 16B. The automated analyte detection and quantification system of Example 13B, wherein the chip caddy contains 1 or more, 4 or more, 10 or more, 20 or more, 50 or more, or 100 or more consumable assay chips.

Example 17B. The automated analyte detection and quantification system of Example 16B, wherein each assay chip contains 2 sample wells, 16 sample wells, 64 sample wells, 256 sample wells, 640 sample wells, 1280 sample wells, 3200 sample wells, or 6400 sample wells.

Example 18B. The automated analyte detection and quantification system of Example 17B, wherein each well has a diameter from about 1 mm to about 5 mm, or from about 1.5 mm to about 3 mm, and wherein two or more wells are interconnected via channels.

Example 19B. The automated analyte detection and quantification system of Example 5B, wherein the voltage power supply is connected to the electrode interface, and wherein the voltage power supply comprises from 1 to 10 independent outputs.

Example 20B. The automated analyte detection and quantification system of Example 1B, wherein the electrode assembly further comprises an automated imager.

Example 21B. The automated analyte detection and quantification system of Example 20B, wherein the automated imager is integrated into the system.

Example 22B. The automated analyte detection and quantification system of Example 20B, wherein the automated imager is separate from the system.

Example 23B. The automated analyte detection and quantification system of Example 20B, wherein the automatic imager comprises a fluorescence reader.

Example 24B. The automated analyte detection and quantification system of Example 23B, wherein the software is configured to integrate and connect the liquid handling robot, the vacuum system, the voltage power supply and the automatic imager.

Example 25B. The automated analyte detection and quantification system of Example 24B, wherein, when the connector assembly and the electrode assembly underneath the connector assembly are in closed position, each electrode in the electrode rails is configured to sit on the edge of each well and to receive electricity through the connector assembly.

Example 26B. The automated analyte detection and quantification system of Example 25B, wherein each electrode has a thickness between 0.1 mm and 1 mm, or between 0.3 mm and 0.7 mm.

Example 27B. The automated analyte detection and quantification system of Example 26B, wherein each electrode is a laser-welded platinum electrode comprising an angled top.

Example 28B. The automated analyte detection and quantification system of Example 27B, wherein the electrode assembly is configured to hold the consumable assay chips in place and maintain electrical conductivity within the wells in the assay chips.

Example 29B. The automated analyte detection and quantification system of Example 28B, wherein the automated liquid handling robot is configured to deliver or aspirate one or more assay reagents to and from one or more wells in the consumable assay chips at different times or in different sequence.

Example 30B. The automated analyte detection and quantification system of Example 1B, wherein the automated system is configured to detect the presence of one or more analytes in a liquid sample and quantify detected amounts of one or more analytes within a period of time from about 10 minutes to about 4 hours.

Example 31B. The automated analyte detection and quantification system of Example 30, wherein the liquid sample is one or more of a biological sample, a cell suspension, supernatant or lysate, plant extracts, seawater, a microfilm fluid, water samples, or a beverage.

Example 32B. The automated analyte detection and quantification system of Example 31B, wherein the biological sample is blood, serum, urine, or a body fluid from a human or an animal.

Example 33B. The automated analyte detection and quantification system of Example 32B, wherein the automated system is configured to detect and quantify one or more of a protein, peptide, antibody, nucleic acid, biomarker, hormone, metabolite, carbohydrate and lipid.

Example 34B. The automated analyte detection and quantification system of Example 33B, wherein detection comprises one or more of an immunoassay, nucleic acid test, multiplex diagnostic test, biomarker measurement or detection, and/or proteomic profiling.

Example 35B. The automated analyte detection and quantification system of Example 1B, wherein the automated system is configured to allow one or more liquid samples and one or more reagents to be separately and at different times introduced into the system.

Example 36B. The automated analyte detection and quantification system of Example 35B, wherein the liquid sample volume is from about 0.2₁11 to about 1000μl.

Example 37B. The automated analyte detection and quantification system of Example 36B, wherein the automated system is configured to detect and quantify one or more analytes in a period of time from about 10 minutes to about 4 hours.

Example 38B. The automated analyte detection and quantification system of Example 37B, wherein the automated system is configured to apply directional electric field.

Example 39B. The automated analyte detection and quantification system of

Example 38B, wherein the automated system is configured to allow a liquid handling robot to precisely transfer, dispense into, deliver to or aspirate from different samples one or more reagents at different times or in different cycles, in order to capture and bind target analytes.

Example 40B. The automated analyte detection and quantification system of Example 39B, wherein capturing and binding target analytes comprise one or more of sandwich antibody detection, enzyme-labeled antigen reaction, fluorometric detection, in situ hybridization, microarray technology, affinity binding, radioactive and colorimetric binding.

It should be recognized that illustrated embodiments are only examples of the disclosed product and methods and should not be considered a limitation on the scope of the invention. Rather, the scope of the invention is defined by the following claims. We therefore claim as our invention all that comes within the scope and spirit of these claims.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. An apparatus used to perform an assay, the apparatus comprising:
a removable chip caddy comprising:
a first frame having one or more assay chips, the assay chips each one or more rows of a plurality of pairs of wells; and
an electrode assembly comprising:
a second frame, the second frame having a plurality of electrode rails connected to the frame, the electrode rails having a plurality of electrodes, wherein the second frame includes recessed notches for removably attaching each of the electrode rails.

2. The apparatus of claim 1, wherein in a closed position, the electrodes of an electrode rail are positioned into one of the wells.

3. The apparatus of claim 2, wherein the electrodes when positioned into one of the wells are offset near an edge of the well thereby allowing clearance for the insertion of a pipette tip into the well.

4. (canceled)

5. The apparatus of claim 1, wherein each of the electrode rails having a first and second connection end with a tip for securely the electrode rail into the recessed notches.

6. The apparatus of claim 1, wherein second frame assembly includes two electrodes rails for each row of the pairs of wells.

7. The apparatus of claim 1, wherein each of the assay chips are removably attached to the first frame.

8. The apparatus of claim 1 further comprising an assembly lid hingedly attached to a base, wherein the assembly lid when in a closed and locked position secures the second frame in place against the first frame.

9. The apparatus of claim 8, wherein the base includes a post, and the assembly lid includes a locking mechanism for locking the assembly lid into the locked position.

10. The apparatus of claim 1, wherein each electrode has a thickness between 0.1 mm and 1 mm, or between 0.3 mm and 0.7 mm.

11. The apparatus of claim 1, wherein each well has a diameter from about 1 mm to about 5 mm, or from about 1.5 mm to about 3 mm.

12. The apparatus of claim 11, wherein each pair of wells are interconnected via channels.

13. The apparatus of claim 12, wherein each well has a volume from about 2.5 μL.

14. The apparatus of claim 1, wherein the second frame comprises multiple spring mechanisms configured to align the first frame with the second frame.

15. The apparatus of claim 1, wherein the electrode rails are configured to be straight and aligned flat and parallel to the rows to sides of the first frame.

16. A method for processing liquid samples, the method comprising:
providing one or more assay chips, the assay chips each including one or more rows of a plurality of pairs of wells, wherein the pair of wells are interconnected via channels;
placing a fluid into wells of the assay chips using a robotic controlled pipettor, having multiple pipettor tips, such that the fluid contacts an electrode positioned within the well, wherein the fluid includes sample molecules;
applying a predetermined voltage via the electrodes to cause the sample molecules to move from a well into the channel; and
aspirating the fluid from the wells using a robotic controlled vacuum aspirator to remove fluid from the wells of the one more assay chips.

17. The method of claim 16, wherein each well has a diameter from about 1 mm to about 5 mm, or from about 1.5 mm to about 3 mm.

18. The method of claim 17, washing each of the wells of the assay chips using a robotic controlled pipettor to dispense a fluid for cleaning, and removing the fluid from the wells.

19. The method of claim 18, the electrodes are positioned within the wells such that the pipettor tips may be inserted within the wells.

20. The method of claim 19, further comprising:
placing a first electrode rail over a first row of the pair of wells, and placing a second electrode rail over a second row of the pair of wells, the electrode rails having multiple electrode tips, wherein the respective multiple electrode tips are positioned into a portion of a well within the row;
applying a first voltage to the first electrode rail; and
applying a second voltage to the second electrode rail.
